(19) United States
(12) Patent Application Publication
(10) Pub. No.: US 2025/0277118 A1
(43) Pub. Date: Sep. 4, 2025

(54) FIRE PROTECTION PASSIVE AND ACTIVE, INTUMESCENT AND WATER-REPELLENT, FIREPROOF COATING SYSTEMS

(71) Applicant: Edgar Francisco Albarrán Ramírez, Ciudad de Mexico (MX)

(72) Inventor: Edgar Francisco Albarrán Ramírez, Ciudad de Mexico (MX)

(21) Appl. No.: 18/594,671

(22) Filed: Mar. 4, 2024

(30) Foreign Application Priority Data
Mar. 4, 2024 (MX) MX/A/2024/002785

(51) Int. Cl. C09D 5/18; C09D 5/16; C09D 7/40; C09D 7/61; C09D 7/63

(52) U.S. Cl. CPC C09D 5/185; C09D 5/1687; C09D 7/61; C09D 7/63; C09D 7/70

(57) ABSTRACT

Fire protection passive and active, intumescent and water-repellent fireproof coating systems are provided, which in its passive system embodiment comprises a new composition of an intumescent and water-repellent fireproof coating with passive preventive fire protection properties and technology not shown by similar products available so far. Said composition is water-based and is manufactured and designed to protect against fire the load-bearing steel metal structures in mixed buildings, walls, floors, and mezzanines by means of rigid thin layers of the composition that provide excellent resistance and thermal protection, which generate a thermal insulating barrier against the ignition source and, once combustion has begun, providing robust protection when exposed to high temperatures and extreme turbulent forces in any type of fire generated by either cellulosic or hydrocarbon-type fire. In its active system embodiment, the composition is in the form of powder, aerosol or silicone.

### FIELD OF THE INVENTION

The focus of this invention is on the fire prevention industry. People familiar with the art will understand that the characteristics of a fire protection passive coating can be easily adapted and found usefulness in industries such as construction, storage, forestry and many other related industries.

### BACKGROUND TO THE INVENTION

The prior art in the field of this invention includes, for example, patent document U.S. Pat. No. 4,529,467, which describes an intumescent curable composition containing an epoxy resin, a curing agent and an additive, the latter comprising a source of phosphoric acid, zinc borate and a blowing agent. Such a composition can have the disadvantage of generating contamination and toxicity during a fire.

International patent application PCT/GB2002/001393 discloses a fire retardant intumescent coating composition comprising: (a) 30 to 60% by weight of a phosphorus-containing material, which decomposes to produce phosphoric acid when the coating is exposed to fire; (b) 10 to 30% by weight of a thermosetting binder; (c) 2.5 to 10% by weight of a curing agent for the thermosetting binder, and (d) 5 to 40% by weight of a thermoplastic binder, wherein the active groups of the thermosetting and thermoplastic binders are chosen so as to impart charring and blowing functions to the intumescent coating composition. Advantageously, the thermosetting binder is a hydroxylated thermosetting binder, suitably an epoxy resin. The thermoplastic binder is advantageously an oxygenated heterocyclic thermoplastic binder, suitably an aldehyde and/or ketone resin. The coating composition may contain 1 to 10% by weight of a colouring agent, suitably titanium dioxide. The coating composition can contain 0.1 to 10% by weight of a melt viscosity modifier, suitably hydrogenated castor oil. The fire retardant intumescent coating composition of this application can form a carbonaceous layer that is porous, soft, and brittle with inadequate resistance to face fire turbulence.

International patent application PCT/EP2014/064892 discloses a thermosetting intumescent coating composition that is suitable for protecting substrates against hydrocarbon fires, e.g., jet fires. The coating composition can be used without a support mesh. The invention disclosed in that patent application also relates to substrates coated with the intumescent coating composition and a method for protecting structures against fire. However, such an intumescent coating composition may not be able to protect steel, which loses structural strength within the first 10 minutes of a hydrocarbon fire when heated.

International patent application PCT/EP2014/064893 discloses an intumescent coating liquid composition comprising the following components: (a) 25.0 to 75.0% by volume of one or more thermosetting organic polymer(s), one or more curing agent(s) for the thermosetting organic polymer(s), (b) 1.0 to 70.0% by volume of a phosphoric or sulfonic acid source, (c) 6.0 to 60.0% by volume of a boric acid source, (d) 0 to 2.0% by volume of melamine or melamine derivatives, (e) 0 to 1.0% by volume of one or more isocyanurate derivatives, wherein the percentage by volume of components (a), (b), (c), (d) and (e) is calculated on the total volume of the non-volatile components in the coating composition. The thermosetting intumescent coating composition is suitable for protecting substrates against hydrocarbon fires, e.g. jet fires. The coating composition can be used without a support mesh. The invention disclosed in the international patent application PCT/EP2014/064893 also relates to substrates coated with the intumescent coating composition and a method of protecting structures against fire.

The thermosetting organic polymer of (a) may comprise at least one of the following functional groups: epoxy, amine, ester, vinyl, vinyl ester, amide, urethane, mercaptan, carboxylic acid, acryloyl, methacryloyl, isocyanate, alkoxysilyl, anhydride, hydroxyl, alkoxyl and polythiol.

An example of a thermosetting organic polymer of (a) is an epoxy resin. Preferably, the thermosetting organic polymer of (a) is an epoxy resin, its curing agent being selected from a curing agent with amine, thiol, carboxylic acid, anhydride and/or alcohol function.

Preferably, the thermosetting organic polymer(s) do not comprise a polysiloxane chain. The thermosetting organic polymer and curing agent are capable of curing to form a coating on a substrate.

A polysiloxane chain is defined as a structure having a Si—O backbone with I organic side groups attached to silicon atoms through a carbon or heteroatom linkage, wherein at least part of the silicon atoms is attached to one, two, or three oxygen atoms.

The thermosetting organic polymer has an organic nature. By organic nature, we mean that the polymer system contains carbon. Therefore, by definition, the organic polymer may not comprise purely polymeric or oligomeric inorganic silicate structures, e.g., sodium or potassium silicate. Additional coatings wherein the binder is solely an alkali silicate which is leachable with water and would not provide a hardwearing/weather (water/corrosion) resistant film suitable for protecting against hydrocarbon fires.

The thermosetting organic polymer may, however, contain heteroatoms and may contain, for example, alkoxysilyl functional groups. Since the thermosetting organic polymer contains carbon, an additional charring agent is not an essential component in the coating composition.

The thermosetting organic polymer may comprise one or a mixture of more than one of the following functional groups: epoxy, amine, ester, vinyl, vinyl ester, amide, urethane, mercaptan, carboxylic acid, acryloyl, methacryloyl, isocyanate, alkoxysil, anhydride, hydroxyl, alkoxyl and polythiol. The intumescent coating liquid composition described in this application when exposed to heat or direct fire can generate carbonaceous layers that expand from 50 to 100 times their dry thickness, this carbon foam is porous, soft, brittle with inadequate resistance to face the turbulence of a cellulosic and hydrocarbon-type fire.

International patent application PCT/CN2017/088391 concerns an intumescent coating composition, an intumescent multi-component coating product, methods for using the intumescent coating composition or the intumescent multi-component coating product, to substrates coated with the intumescent coating composition or the intumescent multi-component coating product. The intumescent coating composition and intumescent multi-component coating product of the invention can have excellent low-temperature resistance and fire-fighting properties. However, the applied layers can be charred in a certain time to contain the fire, but there may be no backing layer left protecting the substrate, compromising the structural stability of the buildings.

### BRIEF DESCRIPTION OF THE INVENTION

Generally, the present invention provides fire protection passive and active, intumescent and water-repellent, fireproof coating systems, which in its passive system embodiment comprises a new composition of an intumescent and water-repellent fireproof coating with passive preventive fire protection properties and technology not shown by similar products available so far. Said composition is water-based and is manufactured and designed to protect steel load-bearing metal structures in mixed buildings, walls, floors, and mezzanines against fire by means of rigid thin layers of the composition that provide excellent resistance and thermal protection, which generate a thermal insulating barrier against the ignition source and, once combustion has started, providing robust protection when exposed to high temperatures and extreme turbulent forces in any type of fire generated either by cellulosic or hydrocarbon-type fire.

This invention provides an intumescent and water-repellent, fireproof coating system with high thermal protection values not present in current products described in the prior art. Each applied rigid thin layer of the composition of this invention surprisingly does not peel off nor disintegrate due to its high adhesion properties to the substrate. And between each layer applied, protects to each element coated therewith against exposure to cellulosic fire, which is generated in front of a combustion source, where said coated elements are materials such as steel, concrete, wood, paper, plastic, cardboard, textiles, drywall, Styrofoam, among others.

According to international standards such as UL-263, cellulosic fire reaches temperatures ranging from 1000 to 1200° F. (538 to 649° C.) wherein steel does not burn; however, in a fire, steel heats up and loses its structural strength within the first 10 minutes of a fire starting.

The present application discloses a intumescent and water-repellent, fireproof coating system with surprisingly high values of protection, cohesion, resistance, and thermal protection that can be applied in at least a rigid thin layer of the coating system composition. In addition, the composition of this coating system has a natural glassy finish that unexpectedly does not crack, peel or disintegrate, due to its surprisingly high adhesion properties to the substrate and between each applied layer of the composition, which protect against exposure to fire by combustible hydrocarbons such as gas, oil, gasoline, diesel, hydrosine, jet fuel, kerosene, which spread in seconds through pipes, conduits and other materials in critical condition that break, spill and can generate fire immediately, generating puddle-type fires, fire jets both in marine and terrestrial environments, in oil and gas facilities.

Safe, immediate, and effective instant fire protection solutions are needed. According to international standards, hydrocarbon fire reaches temperatures ranging 2100° F. (1149° C.) in 5 minutes according to test curves of at least the UL-1709 standard.

Conventional intumescent paints, when applied to steel metal structures for the construction of buildings, have a dry thickness of 0.16 to 0.31 inches (4 to 8 millimeters) when curing, depending on the structure. When exposed to high temperatures, these paints undergo a thermally insulating carbonaceous layer expansion of 50 to 100 times their thickness, above 482° F. (250° C.), which causes the great problem of retarding the heating of the steel, for a time of no more than 60 to 120 minutes of protection.

Therefore, conventional intumescent paints keep the temperature of the steel below 932° F. (500° C.), keeping the strength of steel when a fire starts, with a carbonaceous layer that is brittle to fire turbulence. In addition, all layers applied according to their required thickness are charred at the same time, at the time of their expansion and fire protection.

The novel and surprising intumescent and water-repellent fireproof coating of the present invention provides a first rigid thin layer with a thickness of 0.2524 mils (0.006411 mm) that withstands a temperature of 1652 to 2192° F. (900 to 1200° C.), in determined times of 60 minutes for each rigid and thin layer, to protect the substrate by means of its excellent adhesion properties not seen at the time of the creation of the present invention, thus guaranteeing the stability of steel or other construction materials and the second rigid thin layer exposed to fire does not allow heat transfer, keeping it below its critical yield temperature of less than 932° F. (500° C.), even at high temperatures such as 2012° F. (1100° C.).

By applying the novel and surprising coating composition of the present invention, steel and other construction materials are protected in the event of a high-temperature fire, maintaining their stability and preventing them from collapsing, in specified times of 30 to 240 minutes, by means of their rigid thin layers of coating, avoiding the spread of flames to other adjacent areas, wherein the essential is that the start of the fire is contained in the place it started and mitigated right there by encapsulating the fire without generating toxic fumes. If it is also applied to walls and ceilings, it delays, mitigates and minimizes the effects of fire in any mixed building, protecting real estate and with the main objective of safeguarding people's lives.

The novel and surprising composition of the fire protection passive, intumescent and water-repellent fireproof coating of the present invention comprises the following components: (a) a dehydrating agent, (b) a binding agent, (c) a source of organic acid, (d) a source of organic carbon, (e) organic polymers, (f) a fireproof agent, (g) thermosetting elastomers, (h) an organic adherent agent, (i) a resin agent, and (j) a fiber agent.

The composition of a passive intumescent and water-repellent, fireproof coating of the present invention comprises a suitable dehydrating agent comprising but not restricted to: a group of naturally occurring fibrous metamorphic minerals made up of double-chain silicates, iron, aluminum, sodium and magnesium complexes. Wherein the preferred dehydrating agent is sodium silicate fibers.

Said dehydrating agent may comprise minerals that are part of the phyllosilicate group, a powdered absorbent and a fireproof mineral clay, which is notable for its high porosity, and a mineral to prevent bacterial fermentation. One of its great characteristics is that it has excellent capacity to absorb liquids, including water, solvents or hydrocarbon oils, and as a containment barrier.

Said dehydrating agent comprises natural mineral acrylics hydrated in fiber or powder, sodium, iron, aluminum and magnesium complexes, which are known to be non-toxic, non-corrosive, inert, and not hazardous to health or the environment, in addition to being 100% biodegradable.

In the intumescent and water-repellent, fireproof coating composition of the present invention, the amount of the dehydrating agent is representative between 8% and 19% based on the total weight of the composition, preferably 9-16% by weight, more preferably 10-17% by weight, and still more preferably 10-14% by weight.

The dehydrating agent comprises a fireproof mineral clay, which due to its enormous porosity, is an absorbent of liquids such as water when heat and/or a temperature increase of between 248 to 356° F. (120 to 180° C.) is generated. Its main function in this process is the extraction of water from the binding agent, dissolving the silicates with alkaline cations and anions or analogues to chains, such as sodium ortho-silicate and meta-silicate which are quite soluble in water.

In one embodiment, the passive intumescent and water-repellent fireproof coating composition according to the present invention, comprises a binding agent, which is not restricted to the family of ortho-silicates, meta-silicates and pyro-silicates since any ester containing a chemical group, such as tetramethyl ortho-silicate, can also be used. A preferred binding agent according to the present invention is liquid or powdered sodium silicate.

When water is removed and/or absorbed from the liquid silicate, the silicate becomes progressively more viscous, the removal of water will turn the silicate into a film of glass and microscopic quartz flakes, with a 3:2 weight ratio, being better suited to act as a film binder, a lower alkaline content of a 3:2 ratio silicate provides less affinity for water.

Polymerization reactions occur if the pH falls below 10.7, silicates react with acidic compounds, these cross-link to form “polymers”, the anions of the solutions depend on the concentration of the solution, temperature and various factors, when dissolved silicates are acidified usually by decomposition between 392 to 482° F. (200 to 250° C.), acids are produced that react with other aggregates of the fireproof coating.

When the dehydration of the silicate solution by hydrolysis of the ester and neutralization of the solution occurs, it reacts in the acid to form the acetate anion, which is a carboxylate and is the basis of the acid that is formed by the deprotonation of acetic acid, it is released which changes the pH value to acid, it is a safe and environmentally friendly process.

Silicates dehydrated by esters generate a hardening as a result of hydrolysis reactions, subsequent to the dispersion of the ester in the binder, the ester gradually hydrolyzes forming a weak acid and an alcohol, the acid reacts with the silicate to form potassium and sodium salt, and the binding of hydroxyl groups (OH) in the silicon resulting in gelation, the mixed binding of the silicate and the type of ester used can generate glycerol diacetate, ethylene glycol diacetate and glycerol triacetate, these are the most commercial esters used in state of the art compositions in conventional coatings.

In the intumescent and aqueous fireproof coating composition of the present invention, the amount of binding agent is representative between 46% and 61% based on the total weight of the composition, preferably 46-59% by weight, more preferably 49-60% by weight, even more preferably 48-61% by weight and still more preferably 48-56% by weight.

The passive intumescent and water-repellent fireproof coating composition of the present invention comprises a suitable source of acid, requiring but not restricted to producing acid or acids when the coating of the present invention is confronted with fire.

The acid contains attached silicon, this family of compounds has the formula [SiO x (OH) 4-2 x] n²³; some simple silicic acids are found in split aqueous solutions, such as meta-silicic acid (H₂SiO₃), ortho-silicic acid (H₄SiO₄, PKa1=9.84, PKa2=13.2 at 25° C.), disilicic acid (H₂Si₂O₅) and pyro-silicon acid (H₆Si₂O₇) which in a solid state condense to form polymeric silicic acids of complex structure.

The passive intumescent and water-repellent fireproof coating composition of the present invention comprises a source of organic acid, preferably citric acid additive to silicic acid obtained by acidification of silicate salts.

The amount of the organic acid source represents 0.4 to 2.9% based on the total weight of the fireproof coating composition, preferably 0.4-2.2% by weight, more preferably 0.4-2.7% by weight, even more preferably 0.6-2.9% by weight, and still more preferably 0.5-2.5%.

The fire protection passive intumescent and water-repellent fireproof coating composition of the present invention comprises a source of organic carbon. When the intumescent and water-repellent fireproof coating is exposed to fire or high temperatures, when the binding agent breaks down between 392 and 752° F. (200 and 400° C.) due to increasing of temperature, it provides a source of acids; the binder being agglutinated becomes acidic.

The reaction of the acid source with the active aggregates of the binding agent produces gases such as carbon dioxide (CO₂), water vapor, oxygen, hydrogen, and water, which are released in gaseous form in front of the ignition source, acting as a gasifying or blowing agent (gas source) to generate the rigid thin layer of multicellular carbon.

Conventional intumescent coatings that generate a carbonaceous and foamy layer that grows 50 to 100 times its dry thickness, expand with increasing temperature, this carbonaceous layer absorbs the temperature and thermally insulates the substrate from the fire.

The intumescent and water-repellent fireproof coating composition of the present invention produces a thin and rigid layer of multicellular carbon that is difficult to remove, the inventor of the present invention found that they can use a composition with different organic aggregates, based on carbohydrates that contain carbon in excess, including common carbohydrates, which can be properly selected from one or more monosaccharide groups. An example would be sucrose containing natural isomers: Trehalulose=>glucose to (1→1) fructose; turanose=>glucose to (1→3) fructose (reductor diholoside); maltose =>glucose to (1→4) fructose; leucrose=>glucose to (1→5) fructose (reductor diholoside); isomaltulose (palatinose)=>glucose to (1→6) fructose (reductor diholoside).

The carbohydrates used in the present invention comprise at least one bond linking the O-glycosiolic type monosaccharides. According to the present invention, the preferred carbohydrate is sucrose.

The carbohydrates used in the present invention decompose at a temperature of about 392° F. (200° C.), producing a thermal process involving melting and decomposition; when the agglutinates acidify with the increase in temperature, a sucrose reversal reaction will occur, separating its components from a glucose molecule and a fructose molecule, until its melting point, transforming into a thin layer with a carbonaceous structure. Thus, carbonization is generated in a condensation process removing the water from the sucrose.

Transforming into a thin layer of carbonaceous structure and thermal protection, the material, expanded into a single layer created by an organic polymer in an intermediate pyrolysis sector and the carbonaceous layer provides thermal insulation. A gas source absorbs heat energy during the process of expansion and thermal boiling, forming bubbles that are released and burst on the surface. Gases such as water vapor, oxygen, hydrogen and carbon dioxide (CO₂) are released, isolating the thermal conductivity of the carbonaceous layer before stiffening. Organic polymers contribute to the transformation of the carbonaceous structure thin layer and at the end of the boiling process, to its stiffening.

The amount of organic carbon source is representative at 0.2-2.5% based on the total weight of the intumescent and water-repellent fireproof coating composition of the present invention, preferably 0.2-2.3% by weight, more preferably 0.4-2.5% by weight, even more preferably 0.3-2.1% by weight and still more preferably 0.3-1.8% by weight.

The fire protection passive intumescent and water-repellent fireproof coating composition of the present invention, comprises suitable organic polymers, requiring, but not restricted to, organic polymers and polysaccharides, which may be one or a mixture of more than one different organic polymer.

The organic aggregates resulting from the acidification of the binders used in the present invention to prevent the spread of flames, require, without limitation, materials such as fillers, fibers, clays, fireproof agents, and flame inhibitors, that directly affect radicalary reactions and their gas phase; these aggregates with fireproof properties and characteristics protect and prevent the passage of atmospheric oxygen to the flame sector. These additive aggregates prevent the temperature from affecting the polymer, eliminating the charring cycle, modifying the molecular structure of the polymers and increasing the structural support of the rigid-drying multicellular carbonaceous thin layer during exposure to fire, modifying the decomposition chemistry; these endothermic processes are activated by the fireproof additives that absorb the temperature released during combustion, lowering the temperature and reducing the speed of flame propagation for certain times, preventing combustion.

These flame and fume inhibitors, used in the present invention for a coating, insert variations into the molecules of the polysaccharides by integrating to them. These agents do not maintain the risk of migration, so their fireproof properties and characteristics are preserved for several years without any deterioration, and they do not alter the thermal durability of polymers-polysaccharides (like other retardant additives that need constant maintenance).

In the composition of a intumescent, and water-repellent fireproof coating of the present invention, the amount of suitable organic polymers comprising organic polysaccharide polymers is representative between 0.2-2.9% based on the total weight of the composition, such as preferably 0.2-2.5% by weight, more preferably 0.3-2.4% by weight, even more preferably 0.3-2.9% by weight and still more preferably 0.2-2.1% by weight.

The passive intumescent and water-repellent fireproof coating composition of the present invention comprises a suitable fireproof agent, which requires, but is not restricted to, a group of minerals of volcanic origin present in the earth's crust, a fireproof mortar based on rock wool, vermiculite and perlite or a mixture of more than one suitable different mineral.

In the intumescent and water-repellent fireproof coating composition of the present invention, the fireproof agent contributes to inhibit combustion by affecting radicalary reactions, decreasing flammability and increasing temperature. By means of their refractory microspheres, these endothermic processes activated by fireproof additives that absorb heat radiation form barriers to the passage of oxygen, avoiding the flame zone, interrupting the combustion cycle, thus containing the thermal effects in the area. In addition, it drastically reduces radiant energy levels from 2192 to 77° F. (1200 to 25° C.) in seconds, eliminating the progression of fumes and preventing the spread of fire, thus generating a thermal flame insulation layer with high temperatures, thus maintaining the stability of structural elements against the fire.

In the intumescent and water-repellent fireproof coating composition of the present invention, the amount of the fireproof agent is representative between 1%-4.7% based on the total weight of the composition, preferably 1.1-3.8% by weight, more preferably 1-4.2% by weight, even more preferably 1.4-4% by weight and still more preferably 1.3-4.7% by weight.

In the passive intumescent and water-repellent fireproof coating composition of the present invention, a gas source is generated, suitable for, but not restricted to, compositions containing a compound or set of compounds, which produce gases in the face of exposure to heat or flame.

These gases, usually water vapor, hydrogen (H), nitrogen (N), carbon dioxide (CO₂), can be one or a mixture thereof, they work as a gas source to generate the structural support of a sealant and rigid, multicellular, carbonaceous, rigid, thin layer.

Gases are produced by the reactions of the organic acid source and the binding agent during exposure to fire. Gas generation begins at an increase in temperature at which the acid source decomposes >347° F. (>175° C.) to form acids that react with the binding agent.

Gas sources include organic polymers, monomers, or monosaccharides, which can be one or a mixture thereof. When exposed to an increase in temperature or fire, reactions are generated with thermal decomposition at about 392° F. (200° C.).

In the intumescent, water-repellent fireproof coating composition of the present invention, a gas source is generated, which produces an inflammable gas upon exposure to heat or fire. The coal produced provides excellent strength and thermal insulating protection once combustion is initiated, it provides robust protection when exposed to high temperatures and extreme turbulent forces in any type of fire, whether it is cellulosic type fire or hydrocarbon type fire. Each multicellular rigid thin layer of coating of 10 mils of thikness withstands temperatures from 1112 to 1832° F. (600 to 1000° C.). Each multicellular, charred thin layer of coating hard-to-remove protects an event or fire, if only 2 layers of 20-mil-inch coating were applied. A multicellular rigid thin layer of coating would be left as a backup to protect the substrate from reaching its critical creep temperature, keeping the temperature below 1000.4° F. (538° C.), maintaining the structural stability and strength of the buildings.

The passive intumescent and water-repellent fireproof coating composition of the present invention comprises suitable thermosetting elastomers which require, but are not restricted to, silicones, polyurethanes, neoprenes, rubbers, which may be one or a mixture of more than one different thermosetting elastomer.

Elastomers are highly elastic and viscous polymers made up of long-chain-like carbon, hydrogen, oxygen, or silicon molecules. Their chemical structures have intermolecular cross-links and are able to regain their original shape after being stretched.

Thermosetting elastomers do not deform with increasing temperature or when exposed to fire, they do not melt, they remain in a solid state. Before melting they pass into a gaseous state called sublimation.

High-performance thermosetting elastomer polymers have very high thermal stabilities. Thermoplastic polymers soften with increasing temperature, they become liquid (melt). Thermosetting elastomers, on the other hand, reach a temperature of up to 1256° F. (680° C.). They possess fire-resistant properties and maintain the structure of the multicellular carbonaceous thin layer in a solid state that is difficult to remove and do not allow the organic agents of the composition of the present invention to melt in the combustion zone in the process of intumescence, without degrading, when the fireproof agent mitigates the combustion cycle.

Thermosetting elastomers limit the degradation of organic agents to reduce heat radiation. Flammability is combined with the availability of oxidation of the volatiles produced during degradation, which produce cross-linking leading to the formation of charred residues, which limit the access of volatiles that cool the condensed phase and the release of non-combustible gases, which dilute the gases from the pyrolysis of organic polymers. Inside, the boiling process generates the formation, growth and displacement of bubbles that transport the gases to the surface, preventing the gases from being trapped inside the multicellular carbonaceous thin layer, producing a maximum layer of thermal insulation to eliminate the progression of the fire. This process prevents the fireproof coating from becoming numb, as well as eliminating the emission of fumes.

In the intumescent and water-repellent fireproof coating composition of the present invention, the amount of thermosetting elastomers is representative between 22-37% by weight, based on the total weight of the composition, preferably 24-33% by weight, more preferably 25-36% by weight, still more preferably 26-34% by weight.

The composition to form a passive, generally aqueous intumescent and water-repellent fireproof coating of the present invention comprises a suitable organic adherent agent requiring, but not restricted to, mucilage of Opuntia ficus, obtained from cladodes which is hydrocolloidal and heteropolysaccharide with residues of arabinose, galactose, rhamnose and xylose as neutral sugars.

In a preferred embodiment of the present invention, in the composition to form a passive, generallyaqueous, intumescent, and water-repellent fireproof coating, the amount of an organic adherent agent is representative between 0.1-3.6% by weight based on the total weight of the composition, preferably 0.1-2.9% by weight, more preferably 0.2-3.1% by weight, still more preferably 0.3-3.4% by weight.

The composition to form a passive, generally aqueous, intumescent and water-repellent fireproof coating comprises suitable water-repellent additives, which require but are not restricted to water-repellent agents, ethyl vinyl acetate (EVA), polylactic acid (PLA), calcium stearate, sodium oleate siloxane, redispersible polymers, can be one or a mixture thereof, function as a concept of hydrophobicity.

When water and moisture enter a building, they cause different forms of damage, concrete destruction by corrosion of reinforcing steel, chemical corrosion, decreased thermal protection, degradation of building materials, expansion cracks, shrinkage, freeze and thaw damage, rust stains, moisture, fungus and mold, salt efflorescence from hydration and crystallization and corrosion of metals.

The fireproof and intumescent coating of the present invention, when applied in the form of a rigid thin layer on steel and concrete load-bearing metal structures, walls, floors and slabs, protects them from moisture, preventing possible water infiltration, acts as an integral waterproofing by clogging pores and capillaries. As it is configured with organic and inorganic components, it is not affected by the passage of time, avoiding damage to buildings.

In a preferred embodiment of the present invention, in the composition to form a passive, generally aqueous, intumescent, and water-repellent, fireproof coating, the amount of a resin agent is representative between 0.2-3.7% by weight based on the total weight of the composition, preferably 0.2-2.6% by weight, more preferably 0.3-2.3% by weight, and still more preferably 0.4-2.9% by weight

The composition to form passive a generally aqueous, intumescent and water-repellent fireproof coating of the present invention comprises one or more suitable reinforcing fibers requiring but not restricted to a group of organic fibers and inorganic fibers. Long-chain polymeric synthetic fibers of the thermoplastic group belonging to the family of D-leufins-Polyolefins that originate from the polymerization of propylene derives into polypropylene (PP) and that occur in three molecular structures: isotactic, atactic and syndiotactic with the molecular formula (C₃H₆) n; [CH₂=CH—CH₃] n.

The composition to form a passive generally aqueous, intumescent and water-repellent fireproof coating of the present invention may comprise one or a mixture of more than one inorganic reinforcing fibers, suitable for the composition, e.g., refractory ceramic fibers (FCR) that come from the mixture of aluminum or silica and other refractory oxides have glassy materials and insulating properties at elevated temperatures.

The composition to form a passive generally aqueous, intumescent and water-repellent fireproof coating of the present invention comprises a group of organic fibers and inorganic fibers that may be one or a mixture of more than one different reinforcing fiber, representatively between 0.2-4.1% by weight based on the total weight of the composition, preferably 0.3-3.5% by weight, more preferably 0.2-3.8% by weight and still more preferably 0.5%-3.3% by weight.

### DESCRIPTION OF THE FIGURES

FIG. 1 shows the characteristic intumescent layer made up by prior art products.

FIG. 2 shows the characteristic intumescent layer made up by prior art products.

FIG. 3 shows the characteristic intumescent layer made up by prior art products.

FIG. 4 shows the characteristic intumescent layer made up by prior art products.

FIG. 5 shows a fireproof rigid, multicellular, carbonaceous, thin layer that is difficult to remove produced by the coating effect of the composition of the present invention applied to a galvanized sheet.

FIG. 6 shows a scrape detail in the fireproof rigid, multicellular, carbonaceous, thin layer that is difficult to remove produced by the coating effect of the composition that reveals the thin and, rigid reinforcement layer of white color that protects the substrate after it is subjected to high temperatures.

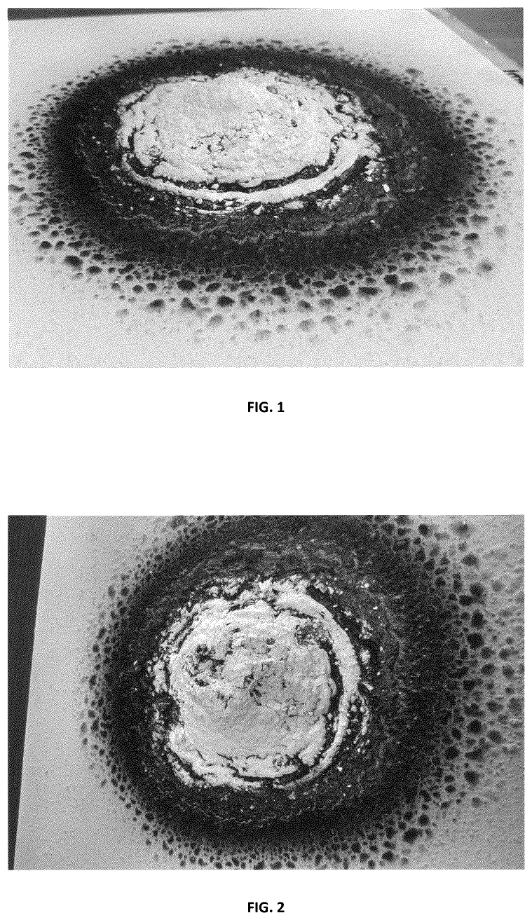

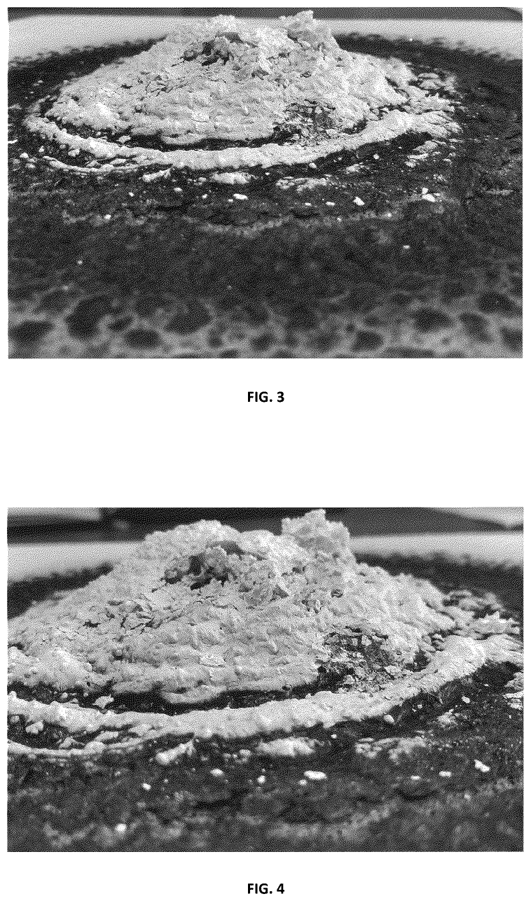

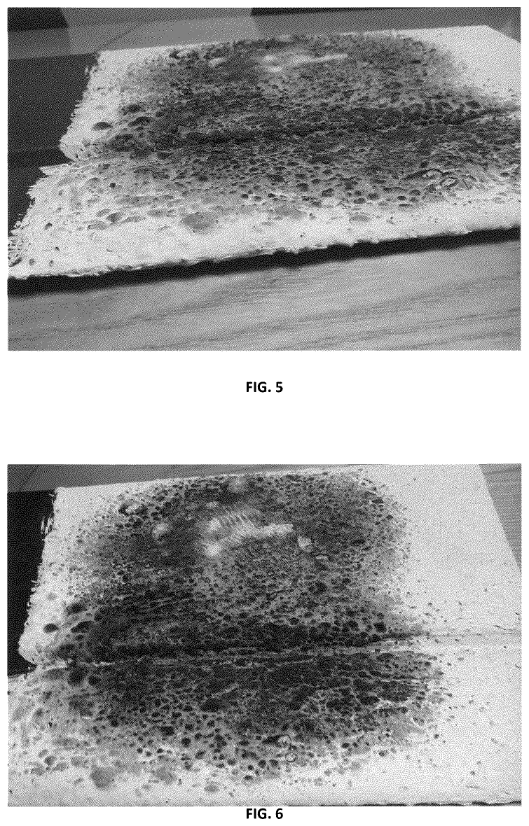

### DETAILED DESCRIPTION OF THE INVENTION

In one embodiment, the present invention provides a water-based, preventive, passive fire protection coating with intumescent properties that is manufactured and developed for the protection of non-burning materials such as concrete and steel, metal steel load-bearing structures. The present invention is a protector against the high temperatures of a fire, to prevent them from losing their properties and stability in buildings.

In another embodiment, the present invention provides a water-based passive fire protection coating with fireproof properties that is manufactured and developed for the protection of flammable materials such as: wood, fiberglass, gypsum panels, recycled PET panels, cardboard, Styrofoam. It is a protector, which protects them from high temperatures in a fire, to prevent them from losing their properties.

Conventional prior art intumescent paints mostly only protect steel metal load-bearing structures, which is the primary purpose for which they are manufactured.

In another embodiment, the present invention provides a water-based passive fire protection coating with thermal insulating properties; each thin rigid layer sealant, with a thickness of 10 mils (0.254 mm), exposed to high fire temperatures, withstands temperatures up to 2012° F. (1100° C.), for each layer applied, does not allow flames nor fume to penetrate, does not allow post-fire heat transfer. The hard-to-remove, multicellular carbonaceous sealant thin layer at 2012° F. (1100° C.) temperature drastically reduces radiant energy levels up to 77° F. (25° C.) in seconds, completely isolating the fire area and maintaining its structural integrity.

Conventional prior art intumescent paints, when exposed to heat or fire, generate carbonaceous layers that expand 50 to 100 times their dry thickness. This carbon foam is porous, soft, brittle with inadequate resistance to face the turbulence of a cellulosic and hydrocarbon-type fire.

Each hard-to-remove multicellular carbonized rigid thin layer of the present invention protects from fire at temperatures of 1112 to 2012° F. (600 to 1100° C.) for 60 to up to 90 minutes, providing time for evacuation. By applying 2 layers of 20 mils (0.508 mm) coating, one thin layer supports the fire front and the other thin layer remains as a backup to protect the substrate, keeping the temperature below 1000.4° F. (538° C.) while preserving the stability, insulation and structural strength of buildings. The fireproof, intumescent, and water-repellent passive fire protection coating composition of the present invention can be applied to any substrate without the need to apply a primer or base coat bonded to the substrate. In particular, in buildings constructed with steel structures where conventional paints do not easily adhere to such steel structures.

Conventional prior art intumescent paints, according to application specifications of paint or coating thicknesses of 39.37 to 196.85 mils (1 mm to 5 mm) once cured, when exposed to high temperatures in front of fire, all applied layers are carbonized in a certain time to contain the fire, but there is no backing layer protecting the substrate, compromising the structural stability of the buildings.

Each hard-to-remove, multicellular carbonized rigid thin layer provided by this invention withstands the extreme turbulent forces in a hydrocarbon fire, is subjected to high temperatures of magnitude 2100° F. (1093° C.) in accordance with the international hydrocarbon fire standard UL1709, and has sufficient thermal insulation capacity to protect the substrate with maximum adhesion. According to the present invention, the fireproof, intumescent and water-repellent composition can be applied in more than two coats to form coatings at requested fire protection times of at least 3 or 4 hours, on the basis that each rigid thin layer withstands 2100° F. (1093° C.) for each hour. In these cases, the application between one layer and another does not require the use of any element such as a support mesh applied between each layer, as is the case in the prior art.

In one embodiment, the present invention provides a fireproof coating of its rigid thin layers, with a glassy finish of mineral quartz that withstands extreme climatic changes such as: sun, rain, wind, UV rays, dust, humidity, water vapor, snow; it does not crystallize, erode, peel off and disintegrate due to its high adhesion properties.

With conventional intumescent paints of the prior art, if the product were to be applied outdoors, a finishing additive or gloss or varnish would have to be applied to improve the properties of the intumescent paints outdoors and this would amount to an additional expense raising application costs.

The fireproof coating of the present invention is non-toxic, does not contain the presence of heavy metals such as: Arsenic (As), Cadmium (Cd), Chromium (Cr), Mercury (Hg), Lead (Pb), Antimony (Sb), Selenium (Se), and is free of halogenated compounds and additives such as: Fluorine (F), Chlorine (Cl), Bromine (Br), and lodine (I).

In conventional prior art intumescent paints, these compounds or additives are common in several of their base formulations, it can be one or a mixture thereof, these substances are effective solutions for thermoplastic materials against fire, but there is pressure from environmental groups for the use of halogenated groups, this causes the development of regulations in Europe that prevent the use of these substances. There is currently a need to replace these substances with compounds that do not generate pollution and toxicity and that are free of halogens and heavy chemicals.

The fireproof and intumescent coating of the present invention is water-based and is configured with organic and inorganic aggregates and raw materials, mineral and vegetable origin, fruits, free of heavy metals, non-toxic, does not generate toxic fumes, all the embodiments of the present invention are environmentally friendly in their manufacturing process.

The present invention provides a boiling process, produces the release of non-combustible gases, generates the formation, growth and displacement of bubbles that transport the gases to the surface, this endothermic process prevents the coating from developing the carbonaceous expansion, inhibits it, it is not essential for a fireproof coating to become numb, it produces a rigid carbonaceous multicellular sealant thin layer that is difficult to remove, it does not generate toxic fumes, encapsulates fire and prevents the spread of flames through compartmentalization.

Conventional prior art intumescent paints, mostly when exposed to increased temperature or fire, the acid source decomposes and the carbonizing agent such as polyhydroxylated alcohols such as pentaerythritol, form a carbon, the flammable gases released by the blowing agent are retained in the film and used to generate a spongy layer which expands 50 to 100 times its dry thickness, this carbonaceous layer is porous, soft and brittle with inadequate resistance to deal with fire turbulence.

The present invention advantageously provides water-repellent properties, by means of hydrophobicity it contains the rise and reach of moisture, the binding agent contains mineral groups of silicate and elements of natural quartz, this mineral is used to form a microscopic network of crystals in the capillary porosities of the fireproof coating, preventing the filtration of water and in turn unexpectedly prevents the crystallization of the thaw.

The present invention provides physical properties in an unexpected way, the fibers serve to reinforce the fireproof coating, its main function is to reduce cracks caused by shrinkage in the pre-set and set state, it prevents micro cracks in tensile states, bending torsion, it reinforces the applied layers keeping them rigid and drying, against high temperatures and fire containment, it reinforces the multicellular carbonaceous layer that is difficult to remove.

The present invention provides a composition to form a fireproof, intumescent and water-repellent coating with passive fire preventive protection properties and technology having unexpected properties. This water-based composition is manufactured and designed to protect load-bearing steel structures in mixed buildings, on walls, floors, and between floors; it provides excellent resistance and thermal protection that generates a thermal insulating barrier against the ignition source, and once combustion is initiated, it provides robust protection when exposed to high temperatures and extreme turbulent forces in any fire generated by either cellulosic or hydrocarbon-type fire.

In one embodiment, the present invention provides a fireproof, intumescent and water-repellent coating system that unexpectedly has high values in thermal protection, in each thin, rigid, applied layer it does not detach or disintegrate due to its high adhesion properties to the substrate and between each layer applied they protect it against exposure to a cellulosic fire, generated against a source of combustion of materials such as steel, concrete, wood, paper, plastics, cardboard, textiles, drywall, Styrofoam, etc.

According to international standards, cellulosic fire is subjected to temperatures ranging from 1000 degrees ° F. (538° C.) to 1200° F. (649° C.) steel does not burn, but in a fire, the steel heats and loss resistance in the first 10 minutes from the beginning of a fire.

The present invention provides a fireproof, intumescent and water-repellent coating system with unexpectedly high values in protection, cohesion, resistance, thermal protection in each rigid thin layer applied. In addition, it has a natural glassy finish that does not crack, does not peel off, does not disintegrate, due to its high adhesion properties to the substrate and between applied layers, protecting the substrate against exposure to a hydrocarbon fire, which is generated in front of the combustion source when there is a fuel leak either gas, petroleum, gasoline, diesel, hydrosine, jet A, jet fuel, kerosene, diesel, etc.

These fuels spread in seconds, in pipes, gutters and other materials in critical condition they break, spill and generate fire immediately, generating puddle-type fires, fire jets in marine and terrestrial environments, oil and gas facilities.

Safe, instantaneous, and effective fire protection solutions are required to overcome the shortcomings of conventional prior art coatings. According to international standard UL1709 hydrocarbon fire is subjected to temperatures ranging from 2100° F. (1149° C.) in 5 minutes according to test curves.

Conventional prior art intumescent paints, when applied to steel metal structures for building construction, at the time of curing, their dry thickness is 0.16 to 0.31 inches (4 to 8 millimeters), depending on the structure. When exposed to high temperatures, these paints undergo a thermally insulating carbonaceous layer expansion of 50 to 100 times their thickness, above 482° F. (250° C.), which retards the heating of the steel, for a set time of 60 to 120 minutes of protection.

Therefore, conventional prior art intumescent paints keep the temperature of steel below 932° F. (500° C.), protecting the steel's resistance when a fire starts, its carbonaceous layer is brittle to fire turbulence, in addition, all layers applied according to their required thickness are carbonized at the same time, at the time of its expansion and fire protection.

In one embodiment, the fireproof, intumescent, water-repellent coating of the present invention can provide at least a first rigid thin layer, 0.2524 mils (0.006411 mm) of thickness, withstanding 1652 to 2192° F. (900 to 1200° C.), at set times of 60 minutes for each thin, rigid layer, to protect the substrate by means of its excellent adhesion properties and ensuring the stability of steel or other materials and at least a second rigid thin layer exposed to fire that does not allow heat transfer, keeping it below its critical creep temperature of less than 932° F. (500° C.), even at high temperatures up to 2012° F. (1100° C.).

By applying the coating of the present invention, steel and other construction materials are protected in the event of a fire of high temperatures, maintaining their stability and preventing them from collapsing, in determined times of 30 to 240 minutes, by means of their thin rigid layers of coating, preventing the spread of flames to other adjacent areas where it is paramount that the start of the fire is contained in the started place and right there it is mitigated by encapsulating the fire without generating toxic fumes. If it is also applied to walls and ceilings, it retards, mitigates and minimizes the effects of fire in any mixed building, protecting real estate and, as its main objective, safeguarding people's lives.

The composition to form the fireproof, intumescent and water-repellent coating with passive fire protection properties and technology of the present invention comprises a combination of the following components: (a) a dehydrating agent, (b) a binding agent, (c) a source of organic acid, (d) a source of organic carbon, (e) organic polymers, (f) a fireproof agent, (g) thermosetting elastomers (h) an organic adherent agent, (i) a resin agent, and (j) a fiber agent.

The composition to form a fireproof, intumescent, water-repellent, passive-technology coating of the present invention comprises a suitable dehydrating agent, which requires, but is not restricted to, a group of naturally-occurring fibrous metamorphic minerals, are mainly composed of double-chain silicates, iron, aluminum, sodium, and magnesium complexes and are classified into two groups: amphiboles and serpentines, amphiboles are a group of minerals of the silicate class, subgroup of inosilicates, meta-silicates of calcium, magnesium and iron.

The components of Amphibole minerals, Amphibiolites are mafic igneous rocks, containing equal amounts of hornblende and plagioclase or ultramafic rocks rich in highly magnesian amphiboles, they also contain minor amounts of mica, quartz, epidote, anthophyllite and garnet, the rocks They originate from pelitic sediments with amphibole and include green pyroxene.

The mineral components of serpentine, with magnesium silicates, especially olivine, pyroxenes and amphiboles, is frequently associated with magnesite, chromite and magnetite, in addition to antigorite and phosterite (olivine) minerals, pH 5.5, the PH values provide magnesium and silicon in the solutions, in the substitution of magnesium ions with other ions, these properties highlight it as a catalyst.

In one embodiment of the present invention the dehydrating agent, is selected from minerals that are part of the group of phyllosilicates, a powdered absorbent and a fireproof mineral clay, its great porosity stands out, and a mineral to prevent bacterial fermentation, one of its great characteristics is excellent for absorption of liquids including water, solvents or oils, hydrocarbons and as a containment barrier.

Such a dehydrating agent comprises fiber or powder, hydrated natural mineral acrylics, sodium, iron, aluminum and magnesium complexes, which are known to be non-toxic, non-corrosive, inert, and not hazardous to health or the environment, in addition to being 100% biodegradable. Its physical properties are longitudinal fibers of 51.18 inches, 94.49 inches, 185.04 inches (1.3 m, 2.4 m, 4.7 m) or powder, its dewatering temperature is between 752 and 932° F. (400 and 500° C.), its melting point between 2732-3092° F. (1500-1700° C.), and its tensile strength: 892.4-1283.7 Mpa (medium strength).

Other components or aggregates more commonly used and known in the art may optionally be included in the prior art products such as catalyst-dehydrating agent, amines: multifunctional organic compounds derived from ammonia, aniline is a primary amine, diethylamine is a secondary amine, trimethylamine tertiary amine, alkyl groups amine proplilamine, primary: methanamine, ethanamine, cyclopentanamine, secondary: N-methyl-propan-1-amine, N-methyl-1-aminopropane-methylmethanamine, methylethanamine, methyl-pentan-3-amine, tertiary: N—N-dimethylethanamine, N—N-dimethylaminoethane, aromatics: aniline, methoxyaniline, pyrrole, pyridine, urea phosphate, melamine phosphate, monoammonium phosphate. This invention does not use them.

In a preferred embodiment of the present invention, the composition to form a fireproof, intumescent, water-repellent, usually aqueous coating, the amount of the dehydrating agent is representative between 8-% and 19% based on the total weight of the composition, preferably 9-16% by weight, more preferably 10-17% by weight, and even more preferably 10-14% by weight.

Prior art products comprise a binding agent, suitable, requires, but is not restricted to, the family of ortho-silicates, meta-silicates and pyro-silicates, it is also used for any ester containing the chemical group such as tetramethyl ortho-silicate; silicate anions are often large polymer molecules with a wide variety of structures, including chains and rings. This invention does not use them.

The natural quartz mineral is found within the group of minerals called silicates that contain elements of silicon and oxygen, which are found in the Earth's crust and mantle. Quartz's formula is SiO₂ and its crystal structures melt at 1112° F. (600° C.). Silicates are minerals with the presence of Orthosilicate ion (SiO₄₄) that can combine to form groups such as phosterite, fayerite, zircon, kaolinite, muscovite, quartz.

A binder can act as an additive capable of agglomerating a material and that can produce a force between the bonds of both, this binder can be found in liquid, solid or powder form, it forms a bridge, film or matrix formulating a chemical reaction to create the union between three vertices and others formulating a chemical reaction to create a structure formed by flat layers that provide the phyllosilicates of a foliated structure.

The dehydrating agent is a fireproof mineral clay, which, due to its enormous porosity, is an absorbent of liquids including water at the time of generating heat and/or an increase in temperature between 248 to 356° F. (120 to 180° C.), its main function of this process is the extraction of water, the binding agent, silicates are dissolved with alkaline cations and anions or chain analogues, such as ortho-silicate and sodium meta-silicate, they are quite soluble in water.

They form various solid hydrates when they crystallize from solution. Cation silicates, non-alkaline or with laminated, three-dimensional polymer anions, generally have negligible solubility in water.

When water is removed and/or absorbed from the liquid silicate, the silicate becomes progressively more viscous, the removal of the water will convert the silicate into a glass film, with a weight ratio of 3:2 and they are better suited to act as a film binder, a lower alkaline content of a 3:2 ratio of a silicate provides less affinity for water.

Polymerization reactions happen if the pH drops below 10.7, silicates react with acidic compounds, which cross-link to form “polymers.” The anions in the solutions depend on the concentration of the solution, temperature, and several factors, when silicates are acidified usually dissolved by decomposition between 392 to 482° F. (200 to 250° C.), acids are produced that react with other aggregates of the fireproof coating.

The binding agent, when broken down by heat or increased temperature, provides a source of acids, the aggregates being agglutinated acidify and are exposed to the reaction of carbon dioxide (CO₂) if not some compounds can be added to the silicate to induce polymerization, such as organic acids, esters or carbonates.

When the dehydration of the silicate solution by hydrolysis of the ester and neutralization of the solution occurs, the binder reacts in the acid to form the acetate anion, being a carboxylate and is the base of the acid that is formed by the deprotonation of acetic acid, which is released which can change its pH value to acid between 2 and 3, it is a safe and environmentally friendly process.

Ester-dehydrated silicates generate hardening as a result of hydrolysis reactions, following the dispersion of the ester in the binder. The ester gradually hydrolyzes to form a weak acid and an alcohol. The acid reacts with the silicate to form potassium and sodium salt, and the binding of hydroxyl groups (OH) in the silicon results in gelation.

In another preferred embodiment of the present invention, in the composition to form a fireproof, intumescent and water-repellent, usually aqueous, coating, the amount of binding agent is representative between 46% and 61% based on the total weight of the composition, preferably 46-59% by weight, more preferably 49-60% by weight, even more preferably 48-61% by weight and still more preferably 48-56% by weight.

In another preferred embodiment of the present invention, the composition to form a passive technology, fireproof, intumescent, water-repellent, generally aqueous coating comprises a source of acid, suitable, requires, but is not restricted to producing acid or acids, when the coating of the present invention is confronted with fire, the acid containing silicon attached, This family of compounds has the formula [SiO x (OH) 4-2 x] n\hat{ }2 3 some simple silicon acids are found in split aqueous solutions, such as meta-silicic acid (H₂SiO₃), ortho-silicic acid (H₄SiO₄, PK a1=9.84, PK a2=13.2 at 77° F. (25° C.)), disilic acid (H₂Si₂O₅) and pyro-silicon acid (H₆Si₂O₇) in solid state condense to form polymeric silicic acids of complex structure.

Silicic acids can be obtained by acidification of silicate salts. In aqueous solution, the main problem is that silicic acids tend to be lost and form silica gel, a form of silicon dioxide that involves condensation processes.

The composition to form a usually aqueous, passive technology, fireproof, intumescent and water-repellent coating of the present invention, comprises a source of citric acid additive to silicic acid obtained by acidification of silicate salts. Citric acid is a tricarboxylic organic acid, which is present in various fruits, such citrus fruits in lemon, orange, tangerine, it is obtained by aerobic fermentation of sugarcane mixture.

Carboxylic acids are highly soluble in alcohols, because they form hydrogen bonding bonds therewith. Also, alcohols are not as polar as water. Long-chain acids are more soluble therein than in water, their general formula is RCOOH, and they contain the functional groups carbonyl and hydroxyl. Citric acid is a weak acid with a pH level between 3 and 6 or equal to most organic acids.

The carboxyl group generates the polarity of the molecule and the possibility of creating hydrogen bonds. The hydrogen in the hydroxyl can dissociate and the compound acts as an acid that includes methanoic acid, ethanoic acid, propanoic acid, and/or butanoic acid.

In a preferred embodiment of the present invention, the amount of the acid source is representative of 0.4 to 2.9% based on the total weight of the composition of the fireproof coating, preferably 0.4-2.2% by weight, more preferably 0.4-2.7% by weight, even more preferably 0.6-2.9% by weight, and still more preferably 0.5-2.5%.

The composition to form a fireproof, intumescent, water-repellent, generally aqueous coating with passive fire protection properties and technology of the present invention comprises a suitable organic carbon source that requires, but is not restricted, at the time the fireproof and intumescent coating is exposed to fire or high temperatures, when the binding agent decomposes between 392 and 752° F. (200 and 400° C.) by increasing temperature, provides a source of acids, the aggregates being agglutinated become acidified.

The reaction of the acid source with the active aggregates of the binding agent produces gases such as carbon dioxide (CO₂), water vapor, oxygen, and hydrogen, which are released in gaseous form in front of the ignition source, acting as a gasifying or blowing agent (gas source) to generate the rigid thin layer of multicellular carbon.

Prior art, conventional intumescent coatings that generate a carbonaceous, foamy layer that grows 50 to 100 times its dry thickness, expand with increasing temperature. This carbonaceous layer absorbs temperature and thermally insulates the substrate from the fire.

Unlike conventional intumescent coatings, the composition to form a usually aqueous, fireproof, intumescent and water-repellent coating of the present invention, produces a thin, rigid layer of multicellular carbon that is difficult to remove. The inventor of the present invention formulated a composition with different organic aggregates, based on carbohydrates containing excess carbon, including common carbohydrates, which can be properly selected from one or more monosaccharide groups. Sucrose contains naturally occurring isomers: Trehalulose=>glucose to (1→1) fructose; turanose=>glucose to (1→3) fructose (reducing diholoside); maltose=>glucose to (1→4) fructose; leucrose=>glucose to (1→5) fructose (reducing diholoside); isomaltulose (palatinose)=>glucose to (1→6) fructose (reducing diholoside).

Reactions with sucrose whose chemical name is a-D-Glucopyronosil-(1→2)-β-D-fructofuranoside, its formula is C₁₂H₂₂O₁₁, it is a disaccharide of glucose and fructose, the molecule is diholoside formed by a bond to (1⇄2) β, its molar mass is 342.3 g/mol is formed by the union of two carbons at its reducing ends, only the alpha anomer of glucopyranose and the B anomer of fructofuranose, the monoclinic crystalline system according to the P21 space group with crystalline parameters a=4.27×10-5 mils (1.08631 nm), b=3.42×10-5 mils (0.87044 nm) and β=102.938°.

Disaccharide carbohydrates generate reactions with sucrose composed of fructose and glucose molecules, including thermal decomposition, which occurs in two stages, dehydration by acids, which produce water and carbons C₁₂H₂₂O₁₁→12C+11H₂O and subsequent oxidation (with oxygen from carbon air to carbon dioxide −12C+12O₂ →12CO₂ is carbonized, sucrose does not melt when heated, it is burned in an exothermic reaction to form water and carbon dioxide (CO₂), with the acids sucrose releases water, carbon dioxide and hydrogen chloride 8HCL O₃+C₁₂ H₂₂ O₁₁ →11H₂O+12CO₂+8HCl.

The hemiacetal carbon of glucose and the hemiacetal carbon of fructose combine in the ionic bond, the hydrolysis of sucrose causes the rupture of the ionic bond releasing glucose and fructose in equimolar amounts. This reaction is very slow that in an aqueous solution of sucrose remains stable for years, but it can ferment or hydrolyze into fructose and glucose, In addition, this process can be controlled and prevent it from crystallizing, allowing its preservation.

The carbohydrates used in the present invention comprise at least one bond that binds the monosaccharides which is of the O-glycosiolic type. In this dicarbonyl bond, the two reducing carbons of both monosaccharides form the alpha (1-2) bond of alpha-D-glucose and beta-D-fructose, it can be selected from one or more groups: beta-D-fructofuranosyl-alpha-D-glucopyranoside, alpha-D-glucopyranosyl-beta-D-fructofuranoside, a-D-glucopyranosyl-(1→2)-β-D-fructoside furanoside; B-D-fructo, furanosyl-(2→1), a-D-glucopyranoside; B-(2S,3S,4S,5R)-fructofuranosyl-a-(1R,2R,3S,4S,5R)-glucopyranoside; a (1R,2R,3S,4S,5R)-glucopyranosyl-β-(2S,3S,4S,5R)-fructo furanoside; (2R,3R,4S,5S,6R)-2-[(25,3S,4S,5R)-3,4-dihydroxy-2,5-bis (hydroxymethyl) oxapent-2-yl]-oxy6-(hydroxymethyl) oxahexane.

The carbohydrates used in the present invention decompose at a temperature of approximately 392° F. (200° C.), producing a thermal process involving melting and decomposition. Configured with different additional organic aggregates, with the increase in temperature a reversal reaction of sucrose will occur, separating its components from a glucose molecule and a fructose molecule. At its melting point, it is transformed into a thin layer with a carbonaceous structure, generating carbonization in a condensation process removing water from sucrose.

Transforming into a thin layer of carbonaceous structure and thermal protection, the material, expanded from a single layer created by an organic polymer in an intermediate sector of pyrolysis and the carbonaceous layer, the gasifying agent absorbs heat energy during the process of expansion and thermal boiling, forming bubbles that release and burst on the surface. Gases such as water vapor, oxygen, hydrogen and carbon dioxide (CO₂) isolate the thermal conductivity of the carbonaceous layer before stiffening.

Other components or aggregates more commonly used and known in the art, such as a carbonizing agent, carbohydrates, polyfunctional such alcohols as: sorbitol, pentaerythritol, dipentaerythritol, tripentaerythritol, resorcinol, polyvinyl alcohol, starch, cellulose powder, hydrocarbon resins, chloroparaffins, phosphate plasticizers that are not used by this invention may optionally be included in the prior art products.

In a preferred embodiment of the present invention, the amount of organic carbon source is representative at 0.2-2.5% based on the total weight of the fireproof, intumescent and water-repellent coating configuration of the present invention, preferably 0.2-2.3% by weight, more preferably 0.4-2.5% by weight, even more preferably 0.3-2.1% by weight, and still more preferably 0.3-1.8% by weight.

The composition to form a usually aqueous, fireproof, intumescent, water-repellent, coating of passive fire preventive technology of the present invention comprises suitable organic polymers, which require, but are not restricted to, organic polysaccharide polymers. It can be one or a mixture of more than a different organic polymer.

In a preferred embodiment of the present invention, organic addition polymers may be one or a mixture of more than a different organic polymer suitable for the configuration of a fireproof and intumescent coating. Polymerization occurs when a catalyst initiates the reaction. This catalyst separates the double carbon bond into the monomers, then the monomers bind to each other due to the free electrons and thus concentrate the bond until the process ends.

Polymers are made up of organic monomers, these are not exempt from combustion, when a polymer is calcined, a thermooxidative reaction is generated that decreases the organic chains of the polymer to monomers of a minimum molecular weight, and in turn gases such as water vapor, hydrogen, carbon dioxide (CO₂), and other ignition aggregates are released.

The increase in temperature causes thermal degradation, contributing to the growth of flames, the temperature of combustion during the boiling process and the formation of bubbles that release gases and break on the surface.

Inside, the polymer continues to degrade until a fireproof agent limits the carbonization of the polymer, this proceeds on the release of volatile agents, and the access of oxygen to the ignition sector, additives, fillers, fibers and fireproof agents, form physicochemical barriers and their effectiveness includes several factors, such as the state of interaction and dispersion with the polymer.

Ignition begins when gases originating from polymer pyrolysis and atmospheric oxygen come together, reaching the maximum temperature inside around 1022° F. (550° C.). The reaction of combustible gases with oxygen is exothermic and together with the endothermic energy reaction of pyrolysis fire propagation occurs.

In another embodiment of the present invention, the organic aggregates used to prevent the propagation of flames, require but are not limited to fillers, fibers, clays and fireproof agents, flame inhibitors, which directly affect radical reactions and reactions, in their gaseous phase. These aggregates with fireproof properties and characteristics protect and prevent the passage of atmospheric oxygen into the flame sector. These additive aggregates prevent temperature from affecting the polymer, eliminating the carbonization cycle, modifying the molecular structure of the polymers, and increasing the structural support of the rigid-sealant multicellular carbonaceous thin layer during fire exposure, modifying the decomposition chemistry. These endothermic processes are activated by fireproof additives that absorb the temperature released during combustion, lowering the temperature and reducing the speed of flame propagation for certain times, preventing combustion.

Flame and fume inhibitors used in the present invention for a coating, insert variations into the molecules of polysaccharides. When integrated, these agents do not maintain the risk of migration, so their fireproof properties and characteristics are preserved for several years without any deterioration. In addition, they do not alter the thermal durability of polymer-polysaccharides (like other retardant additives that need constant maintenance).

Prior art products may optionally include other components or aggregates more commonly used and known in the art, such as thermosetting organic polymer. It can be a resin with epoxy functionality, suitable. It may be one or a mixture that includes (i) polyglycidyl ethers, derived from polyhydroxylated alcohols, such as ethylene glycol, triethylene glycol, 1,2-propylene glycol, 1,4-butylene glycol, 1,5-pentanodol, 1,2,6-hexanotriol, hydrogenated bisphenol-A, or hydrogenated bisphenol-F (ii) polyglycidylic ethers of polycarboxylic acids, epichlorohydrin with an aliphatic or aromatic polycarboxylic acid, succinic acid, terephthalic acid, glutaric acid, oxalic acid, dimerized linoleic acid, (iii) epoxy resins, oxyalkene groups, (iv) olefinically unsaturated alicyclic materials, such as ethers, epoxyalicyclic esters, (v) nonvolacal epoxy resins, are prepared to react to an epihalohydrin that this invention does not use.

In a preferred embodiment of the present invention, in the composition to form a usually aqueous, fireproof, intumescent and water-repellent coating, the amount of suitable organic polymers comprising organic polysaccharide polymers, which may be one or a mixture of more than one different organic addition polymer, is representative between 0.2-2.9% based on the total weight of the configuration, such as preferably 0.2-2.5% by weight, more preferably 0.3-2.4% by weight, even more preferably 0.3-2.9% by weight and still more preferably 0.2-2.1% by weight.

In another preferred embodiment of the present invention, the composition to form a usually aqueous, fireproof, intumescent and water-repellent coating of preventive passive technology comprises a suitable fireproof agent, which requires, but is not restricted to, a group of minerals of volcanic origin present in the earth's crust, the rock wool-based fire-retardant mortar, vermiculite and perlite can be one or a mixture of more than one different mineral. They are naturally occurring minerals of the rhyolite group. The basic composition is an aluminic silicate added with other compounds of iron, magnesium, basaltic rocks; mined in open mines. They have the property of exfoliating when the temperature increases, their growth level in exfoliation is 15 times their real size, it transforms solid lumps of mineral into light porous particles that contain incalculable microspheres of air and water inside.

Mineral aggregates retain their exfoliated structure and withstand high temperatures with the action of fire, until they reach their melting point of 2462° F. (1350° C.). Inside, the polymers and minerals degrade, until the fireproof limits the carbonization of the organic aggregates, forming physicochemical barriers, generating an airtight and thermally insulating film against the high temperatures of the fire. The fireproof acts as a lightweight additive in fireproof mortars.

In another preferred embodiment of the present invention, in the composition to form a usually aqueous, fireproof, intumescent and water-repellent coating, the fireproof agent contributes to the objective of inhibiting combustion by affecting radical reactions, decreasing their flammability and increasing temperature, by means of their refractory microspheres. These endothermic processes activated by fireproof additives that absorb heat radiation form barriers to the passage of oxygen, avoiding the flame zone, interrupting the combustion cycle and containing the thermal effects in the area. In addition, it unexpectedly drastically reduces radiant energy levels from 2192 to 77° F. (1200 to 25° C.) in seconds, eliminates fumes progression, and prevents the spread of fire. It generates a layer of thermal insulation to flames at high temperatures, maintaining the fire stability of the structural elements.

In another preferred embodiment of the present invention, in the composition to form a usually aqueous, fireproof, intumescent and water-repellent coating, the amount of the fireproof agent is representative between 1%-4.7% based on the total weight of the composition, preferably 1.1-3.8% by weight, more preferably 1-4.2% by weight, even more preferably 1.4-4% by weight and still more preferably 1.3-4.7% by weight.

In the composition to form a usually aqueous, fireproof, intumescent, water-repellent coating of preventive passive technology of the present invention, a suitable gas source is generated, which is not restricted to, compositions containing a compound or set of compounds that produce gas in the face of exposure to heat or flame.

These gases, usually water vapor, hydrogen (H), nitrogen (N), carbon dioxide (CO₂), can be one or a mixture thereof, function as a gas source to generate the structural support of a rigid carbonaceous multicellular sealant thin layer.

Gases are produced by the reactions of the organic acid source and the binding agent during exposure to fire. Gas generation is initiated by increasing the temperature at which the acid source decomposes >347° F. (>175° C.) to form acids that react with the binding agent.

Gas sources include organic polymers, monomers or monosaccharides can be one or a mixture thereof, when exposed in an increase in temperature or in the face of fire, reactions are generated with thermal decomposition about 392° F. (200° C.).

Dehydration by water-producing acids, carbons and oxidation with oxygen from the air or carbon dioxide (CO₂) and water, configured with different additional organic aggregates, decompose to release gases.

The composition of a fireproof, intumescent and water-repellent coating contains an organic carbon source that can be a solid or liquid carbon source or a combination thereof. These polymers are used as a source of the gas when exposed to fire and react with the acid source.

This organic carbon source forms a thin layer of sealing, rigid multicellular carbonaceous structure, expanding up to 10 times its dry thickness, when it reaches a temperature between 392 and 572° F. (200 and 300° C.).

Gasification results in the release of non-combustible gases. Inside, the boiling process generates the formation, growth and displacement of bubbles that transport the gases to the surface, preventing the gases from being trapped inside the carbonaceous layer. By means of this process, the coating is prevented from developing conventional intumescence, it is not essential for a fireproof coating to become intumesced.

In another preferred embodiment of the present invention, the composition to form a usually aqueous, fireproof, intumescent, water-repellent coating generates a gas source, which produces a flammable gas upon exposure to heat or fire. The coal produced provides excellent strength and thermal insulating protection once combustion has begun, providing robust protection when exposed to high temperatures and extreme turbulent forces in any type of fire, whether cellulosic type fire or hydrocarbon type fire. Each rigid multicellular thin layer of 10 mils (0.254 mm) thick coating withstands temperatures from 1112 to 1832° F. (600 to 1000° C.). Each hard-to-dry, multicellular, hard-to-remove carbonized thin layer protects an event or fire. If only 2 layers of 20 mils (508 mm) thickness coating were applied, a rigid multicellular thin layer of coating would be left as a backup to protect the substrate, preventing it from reaching its critical yield temperature, keeping the temperature below 1000.4° F. (538° C.), maintaining the structural stability and strength of the buildings.

Conventional intumescent coatings of prior art products, when exposed to temperature increase or fire, the acid source decomposes to form an acid and the carbonizing agent forms carbon by means of forming agents such as polyhydroxylated alcohols such as pentaerythritol or dipentaerythritol, carbon is obtained by decomposition of polyhydroxylated alcohol, the flammable gases released by the blowing agent are retained in the film and are used to form the carbon and generate a spongy layer that can expand to 50 to 100 times its dry thickness, which insulates and protects the substrate at certain times that are not used in this invention.

The carbonaceous layer of traditional prior art coatings mostly comprises applied layers of coating typically of thickness from 0.039 to 0.315 inches (1 to 8 millimeters) All these layers carbonize in the same event of temperature increase or exposure to fire, exposing the substrate, because there is no protective layer adhered to the substrate.

After the protection time, the carbonaceous layer of traditional prior art coatings mostly loses adhesion, thermal insulation, and structural integrity properties. The residues of this porous foam are soft, brittle with inadequate resistance to deal with the turbulence of fires.

Prior art products may optionally include other components or aggregates more commonly used and known in the art such as melamine-derived blowing agents are known in the art, melamine cyanorate, melamine (mono) phosphate, dimelamine phosphate, melamine bisphosphate, melamine pyrophosphate, melamine polyphosphate, melam (1,3,5-triazine-2,4,6-triamine-n-(4,6-diamino-1,3,5-triazine-2-yl), melem (2,5,8-triamino-1,3,4,6,7,9,9b-heptaazaphenalene), methiolated melamine, hexamethoxymelamine which this invention does not use.

The composition to form a fireproof, intumescent, water-repellent, usually aqueous, passive technology coating of the present invention, comprises thermosetting elastomers, suitable requiring but not restricted to silicones, polyurethanes, neoprenes, rubbers, which may be one or a mixture of more than one different thermosetting elastomer.

Elastomers are highly elastic and viscous polymers made up of long-chain molecules of carbon, hydrogen, oxygen, or silicon. Their chemical structures have intermolecular cross-links and are able to regain their original shape after being stretched.

Thermosetting elastomers do not deform or melt and remain in a solid state when exposed to fire. Before melting, they go into a gaseous state called sublimation.

High-performance thermosetting elastomer polymers have very high thermal stabilities. Thermoplastic polymers soften with increasing temperature, they become liquid (melt). Thermosetting elastomers, on the other hand, reach a temperature of up to 1256° F. (680° C.). They possess fire-resistant properties and maintain the structure of the multicellular carbonaceous thin film in a solid state that is difficult to remove and do not allow the organic agents of the composition of the present invention to melt in the combustion zone in the process of intumescence, without degrading, when the fireproof agent mitigates the combustion cycle.

Thermosetting elastomers limit the degradation of organic agents to reduce heat radiation. Flammability is combined with the availability of oxidation of the volatiles produced during degradation, which produce cross-linking leading to the formation of carbonized residues, which limit the access of volatiles that cool the condensed phase and the release of non-combustible gases, which dilute the gases from the pyrolysis of organic polymers. Inside, the boiling process generates the formation, growth and displacement of bubbles that transport the gases to the surface, preventing the gases from being trapped inside the thin multicellular carbonaceous layer, producing a maximum layer of thermal insulation to eliminate the progression of the fire. This process prevents the fireproof coating from becoming numb, as well as eliminating the emission of fumes.

In the composition to form a fireproof, intumescent, water-repellent, usually aqueous, passive technology coating of the present invention, the amount of thermosetting elastomers is representative between 22-37% by weight, based on the total weight of the composition, preferably 24-33% by weight, more preferably 25-36% by weight, still more preferably 26-34% by weight.

The composition to form a fireproof, intumescent, water-repellent, usually aqueous, passive technology coating of the present invention, comprises a suitable organic adherent substance, which requires, but is not restricted to, the mucilage of Opuntia Ficus, obtained from cladodes that is hydrocolloidal and heteropolysaccharide with residues of arabinose, galactose, rhamnose, and xylose as neutral sugars.

Once the coating has been cured and applied to steel structures and other substrates, when exposed to fire, a decomposition of dehydrating agents occurs between 248 and 356° F. (120 and 180° C.), these mineral clays extract the water contained in the binding agent and the mucilage of Opuntia Ficus once this viscous plant substance has been dehydrated. It acts as an organic adherent additive.

The water extracted from the agents helps the exothermic boiling process, for the formation of bubbles that release gases and break at the surface. Inside, the fireproof limits the carbonization of organic aggregates to reduce heat radiation, producing a maximum layer of thermal insulation, to eliminate the progression of fire.

It forms an adherent protective layer that reacts against the ignition source, if two thin layers of coating are applied, the protective layer adheres between the multicellular carbonaceous layer and the inner rigid thin layer of support, providing thermal protection, high adhesion properties that withstand extreme turbulent forces in a hydrocarbon fire. In addition, it has a natural glassy finish, preventing it from reaching its critical creep temperature of 1000.4° F. (538° C.), maintaining its stability and preventing it from collapsing.

In a preferred embodiment of the present invention, in the composition to form a fireproof, intumescent, and water-repellent, usually aqueous, passive technology coating, the amount of an organic adherent substance is representative between 0.1-3.6% by weight based on the total weight of the composition, preferably 0.1-2.9% by weight, more preferably 0.2-3.1% by weight, still more preferably 0.3-3.4% by weight.

In one embodiment of the present invention, the composition to form a fireproof, intumescent, and water-repellent, usually aqueous, passive technology coating comprises suitable water-repellent additives, requiring but not restricted to one or more water-repellent agents, ethyl vinyl acetate (EVA), polylactic acid (PLA), calcium stearate, sodium oleate siloxane, redispersible polymers. They can be one or a mixture thereof, they work as a concept of hydrophobicity, the ability of the substance to repel water, these additives act by forming a barrier that prevents the passage of water and the ions that accompany it.

When water and moisture enter a building, they cause different forms of damage, concrete destruction by corrosion of reinforcing steel, chemical corrosion, decreased thermal protection, degradation of building materials, expansion cracks, shrinkage, freeze and thaw damage, rust stains, moisture, fungus and mold, salt efflorescence by hydration, crystallization and corrosion of metals.

The fireproof and intumescent coating of the present invention, when each rigid thin layer is applied to the load-bearing metal structures of steel and concrete, walls, floors and slabs, protects them from moisture, preventing possible water infiltration, acts as an integral waterproofing clogging pores and capillaries. As it is configured with organic and inorganic components, it is not affected by the passage of time, avoiding damage to buildings.

In a preferred embodiment of the present invention, in the composition to form a fireproof, intumescent, and water-repellent, usually aqueous, passive technology coating, the amount of a resin agent is representative between 0.2-3.7% by weight based on the total weight of the composition, preferably 0.2-2.6% by weight, more preferably 0.3-2.3% by weight, and still more preferably 0.4-2.9% by weight.

The composition to form a fireproof, intumescent, water-repellent, generally aqueous, passive technology coating of the present invention comprises one or more suitable reinforcing fibers requiring but not restricted to a group of organic fibers and inorganic fibers. The long-chain synthetic polymeric organic fibers of the group of thermoplastics belonging to the family of Dleufinas-Polyolefins that originates from the polymerization of propylene derives into polypropylene (PP) and that occur in three molecular structures: isotactic, atactic and syndiotactic with the molecular formula (C₃H₆) n; [CH₂=CH—CH₃] n.

This structure provides the highest degree of polymer crystallinity (>50%) and gives polypropylene the PP fibers used as 100% virgin multifilament fibers used as secondary reinforcements of composite materials in fireproof coatings. They have a linear, semi-crystalline isotactic molecular structure with regular geometry and helical shape, it is formed by long and complex aggregates of crystallites called spherulites.

The polypropylene used in the present invention is a toxic-free, eco-friendly, corrosion-resistant plastic, with Plastics Recycling (PP) Category No. 5. It is a plastic authorized to be in contact with food, laboratory equipment and medical applications.

The composition to form a usually aqueous fireproof, intumescent, water-repellent, passive technology coating of the present invention, may comprise one or a mixture of more inorganic reinforcing fibers, suitable for the composition, e.g., refractory ceramic fibers (FCRs) that come from the mixture of aluminum or silica and other refractory oxides have glassy materials and insulating properties at elevated temperatures.

In another embodiment of the invention, it may be preferred that in the composition to form a usually aqueous fireproof, intumescent, water-repellent, passive technology coating, the fiber agent may be one or a mixture of more than one reinforcing inorganic fiber, suitable for the composition. Glass fibers are composed of various metal oxides such as silica, alumina, lime, magnesium and inorganic mineral oxides. Type E glass reinforcing fibers, which are dielectric, are used for the reinforcement of type D composites in radars and type R fibers contain high tensile strength and are used for the aeronautical and marine industry.

The main function of the polymeric synthetic inorganic fibers of the present invention is to reduce cracks caused by shrinkage, prevent micro cracks, anti-seepage of liquids, avoid fractures in tensile states of traction, bending, shear stress, torsion, provide maximum adhesion to aggregates and resistance to impacts that are dispersed over a multidirectional network to reinforce each rigid thin layer applied of the fireproof, intumescent and water-repellent coating.

Reinforcing fibers, which can be one or a mixture of more than one organic fiber and/or inorganic fibers, provide more resistance to wear and environmental degradation with extreme weather changes, such as rain, sun, wind, UV rays, dust, moisture, water vapor, snow and prevent crystallization. It protects the natural glassy finish of each rigid thin layer applied and eliminates the possibility of instability in the face of high temperatures and fire containment.

Microfibers according to the present invention may have a length of 0.4724 inches to 2.95 inches (12 mm to 75 mm), grouped into thermoplastic monofilaments, aluminum, silica or glass with a diameter of 0.6299 to 1.38 mils (16 to 35 μm), with a breaking strength of 18.07 lb (8.2 Kg), a length of 0.1181 to 1.96 inches (3 to 50 mm) of each monofilament and an ignition point of 674.6° F. (357° C.).

Other components or aggregates such as inorganic fibers, carbon fibers such as: boron carbide fibers, niobium carbide fibers, silicon carbon fibers, aluminum-boron-silica fibers, glass fibers E (non-alkaline alumina boron silicate fibers), C glass fibers (non-alkaline soda lime), C glass fibers (non-alkaline or low-alkaline soda-alumo borosilicate), glass fibers A (alkaline-silicate soda lime), mineral glass fibers, aluminium-silicate non-alkaline fibers, quartz fibers, silica fibers, high-silica alumina fibers, alumosilicate fibers, alumosilicate fibers, soda silicate fibers, polycarbosilane fibers, metal fibers, namely iron fibers, aluminium fibers, steel fibers, zinc fibers, etc., may be optionally included in prior art products, these fibers can be formed by any physical or chemical process and any mixture thereof. This invention does not use them.

In one embodiment of the present invention, the composition to form a usually aqueous fireproof, intumescent, water-repellent, passive technology coating of the present invention comprises a group of organic fibers and inorganic fibers that may be one or a mixture of more than one different reinforcing fiber, representatively between 0.2-4.1% by weight based on the total weight of the composition, preferably 0.3-3.5% by weight, more preferably 0.2-3.8% by weight and even more preferably 0.5%-3.3% by weight.

Ethylene vinyl acetate (EVA) is a thermoplastic polymer made up of repetitive units of ethylene and vinyl acetate, its semi-developed formula (C₂H₄) n (C₄H₆₀₂) m, it is totally ecological and very light, it is a non-toxic and recyclable product that is very versatile, it is a polymer very close to elastomers in terms of flexibility, it can be processed just like thermoplastics, being a thermoplastic elastomer.

Ethyl vinyl acetate (EVA) contains barrier properties, low temperature resistance, stress-cracking resistance, waterproof hot melt adhesive properties, UV radiation resistance, and is odorless.

The copolymer ethylene vinyl acetate is an addition polymer made up of repeating units of ethylene and vinyl acetate.

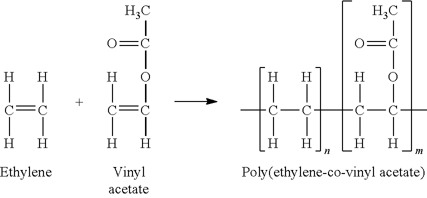

The incorporation of vinyl acetate into the ethylene polymerization process produces a copolymer with a lower crystallinity than that of common ethylene homopolymer, therefore, these lower crystallinity resins have lower melting temperature and thermosealing temperature, and reduce stiffness.

Calcium sterate is a water-repellent agent used in polymers mainly in PVC, it is a slipping agent that has lubrication properties in plastics, acts as an acid remover or neutralizer, lubricant, and release agent for its maximum resistance to water impregnation. Its formula C₃₆ H₇₀ C_{9 04} is defined as the metal salts of a fatty acid with an 18-carbon chain, known as stearic acid, such as metal oxides, metal hydroxides, metal sulfates and metal chlorides.

Sodium oleate is a reactive hydrophobic agent, it provides protection on the surface and in the mass, it is an additive and is an organic compound, its chemical formula C₁₈ H₃₃ Na O₂, sodium is the main component for the reaction of sodium hydroxide and oleic acid, which is an unsaturated fatty acid and is the most abundant fatty acid in nature.

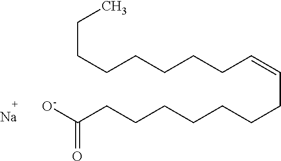

Optionally, silane can be used in the present invention, which is a hydrophobic agent, indispensable in the cementation process for bonding strength. It provides protection to the fireproof coating and increases resistance against water and weathering, as well as the onslaught of chlorides, and environmental contaminants. It is not a vapor barrier so it allows the wall to breathe, its formula SiH4, silicon hydroride decomposes into silicon and hydrogen above 788° F. (420° C.), can be used in the chemical deposition of silicon vapor.

Siloxanes are other hydrophobic agents; they are a functional group of organosilicon with the Si—O—Si bond. They include oligomeric and polymeric hydrides. Its formulas H (OSiH2) n OH and (OSiH2) n, are a main part of silicones such as polyodimethyl siloxane of the functional group R3SiO called siloxy, are artificial and have several industrial applications due to their hydrophobic characteristics, low thermal conductivity and high flexibility.

Organic compounds formed by linear or cyclic chains of silicon, oxygen, and methyl groups include high and low viscosity fluids, rubbers, elastomers, and resins. Silicones are siloxane or polysiloxane polymers, they are a mixture of inorganic and organic polymers, whose chemical formula is [R2SiO] n, wherein R belongs to organic groups such as methyl, ethyl or phenyl.

Redispersible polymer powders can be used optionally in the present invention and are made by atomizing organic materials, producing high adhesion strengths in vitrified and low absorption materials, based on the application of thin layers of the coating. The redispersible powder derives from the behavior of the particles when in contact with water, during hardening elastic polymeric bonds are created between the mineral components of the fireproof coating.

The polymer modification additionally gives flexibility to the system and improves thixotropy, fluidity and water retention, due to its hydrophobic impregnation.

The matrix of the composition of the crystallization resin agent is composed of a mixture with calcium silicate, which by reacting with a chemical base of amino alcohols and organic minerals that are dispersed together with the binding agent containing quartz minerals, the silicate becomes progressively more viscous. The removal of water absorbed by the dehydrating agent will convert the silicate into a quartz glassy film on the outside of each rigid thin layer of fireproof coating.

Additionally, silicate dehydration and crystallization are generated, converting siliceous sand into microscopic quartz flakes. Together, the water-repellent agents are mixed with bituminous emulsions, waxes, fatty acids and butylostereates, substances that allow lubrication, causing all of them to slide through the internal capillary system of the fireproof coating, which activates the substances inside and forms invasive non-soluble quartz crystals, which obstruct the entire capillary microscopic network in any crack up to 0.0016 inches (0.04 millimeters) thickness, preventing the filtration of water and moisture, drying the fireproof coating completely.

The composition to form a usually aqueous fireproof, intumescent, water-repellent, passive technology coating of the present invention, under curing conditions drying is at room temperature 64.4-86° F. (18-30° C.). As a priority, the coating is cured by physical drying in natural environmental conditions with the volatilization of water and organic aggregates, present in the composition. To generate the proper setting, it is recommended to take 24 to 36 hours depending on the temperature, to avoid lumps on the rigid surface for each rigid thin layer applied, until homogeneous setting and hardening is obtained.

### Examples of Application of the Invention

In a foundry factory, samples 1˜4 were prepared, the fireproof, intumescent, water-repellent coating containing the composition of the present invention was applied directly without primer, formed in the soil, and the test consisted of direct emptying of incandescent copper smelting material at a temperature of 2264° F. (1240° C.). Sample 1 consisted of a 11.81×11.81 inches (300×300 mm) and 0.3937 inches (10 mm) thickness stainless steel square plate. This sample was given 2 thin coats of coating with a total film thickness of 20 mils (0.508 mm).

Sample 2 consisted of a 7.87×7.87 inches (200×200 mm) and 0.3937 inches (10 mm) thickness stainless steel square plate. This sample was given 3 thin layers of coating with a total film thickness of 30 mils (0.762 mm).

Sample 3 consisted of a round stainless-steel plate 7.87 inches (200 mm) in diameter and 0.3937 inches (10 mm) thickness. This sample was subjected to 4 thin layers of coating with a total film thickness of 40 mils (1.016 mm).

Sample 4 consisted of a round stainless steel plate 7.87 inches (200 mm) in diameter and 0.3937 inches (10 mm) thickness. No coating was applied to this sample.

The square and round stainless steel plates were air-sprayed and allowed to dry at room temperature of 90° F. (32.2° C.). For curing, at least 24 hours were required for each coat; After a week of curing, the pieces were left with optimal homogeneous hardening. Samples 1-3 were coated on one side with the fireproof, intumescent and water-repellent coating containing the composition of the present invention.

Qualified personnel of the foundry poured the “lava” copper smelter directly on each of the faces of the samples with the fireproof, intumescent and water-repellent coating containing the composition of the present invention. Immediately fire was generated in each of the samples after a few minutes, the fire was mitigated and the copper in each of the samples hardened, being captured as a film on each of the samples. Subsequently, in seconds, the copper film was removed and the molten copper was detached in a solid state.

The composition to form the fireproof, intumescent and water-repellent coating generated a difficult to remove thin, multicellular carbonaceous layer, which had to be scraped with a tool (screwdriver) to remove it, which withstood in seconds the lava poured at a temperature of 2264° F. (1240° C.) and mitigated the fire that was generated.

The fireproof and intumescent coating, surprisingly with a single thin layer, withstood the incandescence of the molten copper poured thereon and then when it was removed, under this thin outer carbonaceous layer, the next rigid thin layer continued, white in color, when what would be expected would be that the applied layers of the fireproof coating would separate immediately on contact with the copper smelt due to incandescence.

This temperature resistance test of 2264° F. (1240° C.) was performed on the three steel samples mentioned above with different coating thicknesses. The same result happened in each sample, the first thin outer layer was charred.

After scraping samples 1, 2 and 3 and observing the next thin layer rigid in white, the fireproof coating surprisingly drastically reduced the temperature from 2264 to 77° F. (1240 to 25° C.) in less than 120 seconds, which was confirmed with a pyrometer, K-type thermocouples, and to the touch on each steel plate.

With respect to sample 4 of round steel plate, which was not coated with fireproof coating, the result was that the copper film was removed, but the plate was stained with a black mark of the casting material. The temperature of the plate did not drop below 1328° F. (720° C.) measured with a pyrometer and K-type thermocouples during the first 30 minutes after the lava was emptied and it was impossible to touch the piece, there was still heat radiation that made it impossible to touch it.

In another test, a log of wood is the test sample, with a length of 23.62 inches (600 mm) and a diameter of 7.08 inches (180 mm), the surface of the log was completely cleaned and environmentally dried for 3 days at a temperature of approximately 82.04 to 89.6° F. (28 to 32° C.) to prevent it from containing moisture inside.

The log was drilled using a drill and a 0.5 inch (12.7 mm) drill bit, at a height of 3.93 inches (100 mm) from the top down, to enter the hole a thermocouple 3.54 inches (90 mm) deep, toward the center of the log so that the internal temperature of the log could be taken. In this position, the temperature was measured in 10-minute intervals with an additional pyrometer.

Once the sample was prepared, it was coated with fireproof and intumescent coating, two thin, rigid, white coats were applied, wherein the two thin rigid white layers were applied over the entire surface of the sample, with a layer thickness of 10 mils (0.254 mm) each layer, by air spraying. For curing 24 hours were required for each layer applied, for 20 mils (0.508 mm) 48 hours of curing were required and thus a homogeneous setting and hardening was achieved.

The sample was exposed to fire from a butane gas torch that generated a direct fire flame that was applied at a fixed point on its periphery, thermocouples were fixed at the fixed point of fire application to measure temperature increases. Within 5 minutes the temperature reached 842° F. (450° C.) and within 10 minutes the temperature was raised to 1895° F. (1035° C.), subsequently fire exposure and temperature remained substantially stable.

According to the present invention, the coating composition produced a carbonization process of the fireproof, intumescent and water-repellent coating in its applied rigid thin layers, when exposed to high temperatures in the first 10 minutes. The composition of the present invention did not allow flames or smoke to penetrate, nor did it allow heat transfer, completely isolating the radiation by its rigid carbonaceous multicellular sealing thin layers. They proved difficult to remove by instantaneously absorbing and repelling heat energy, withstanding temperatures of 1112 to 1940° F. (600 to 1060° C.) for a set time of 60 to 80 minutes of protection against fire, while the second rigid thin layer of 10 thousandths of an inch (0.254 mm) thick provided the insulation. stability and structural strength of the wood sample, protecting it from flames reaching the substrate.

As a result of the application of the composition in the coating of the present invention, it was surprisingly obtained that there was no high heat transfer and the temperature within the wood log sample had extremely low variation values of no greater than 50° F. (10° C.) for time intervals that were 5 to 10 minutes as seen in the table below. These extremely low temperature variations were obtained despite the fact that the temperature outside the wood log sample was above 1832° F. (1000° C.) over a total time interval of 80 minutes.

| Time | Temperature [° F.] | Temperature [° F.] |
|---|---|---|
| [min] | Hot Face | Cold Internal |
| 0 | 79 (26° C.) | 79 (26° C.) |
| 5 | 842 (450° C.) | 81 (27° C.) |
| 10 | 1895 (1035° C.) | 97 (36° C.) |
| 20 | 1917 (1047° C.) | 97 (36° C.) |
| 30 | 1940 (1060° C.) | 99 (37° C.) |
| 40 | 1877 (1025° C.) | 95 (35° C.) |
| 50 | 1886 (1030° C.) | 86 (30° C.) |
| 60 | 1868 (1020° C.) | 90 (32° C.) |
| 70 | 1796 (980° C.) | 84 (29° C.) |
| 80 | 140 (60° C.) | 79 (26° C.) |

This test showed that the rigid thin inner layer protects the substrate and provided thermal insulation, stability, watertightness and resistance to the wood inside without generating fume.

The first thin, hard-to-remove, multicellular carbonaceous layer after removing the direct flame that reached a temperature of 1940° F. (1060° C.), was also surprising because in the first 30 seconds it was reduced to the initial temperature of the test, which was simply and surprisingly corroborated by touch. To do this, we leave our hands on the wooden trunk and do not perceive the radiation of a burnt product, only warm-cold, touching it for 1 minute.

Afterwards we remove the difficult to remove, thin multicellular carbonaceous layer, we remove it with a sharp tool (screwdriver) scraping hard it is scratched, it is removed and residues of carbonization powder remain, but underneath follows the next thin rigid white layer of support to protect the wooden trunk.

The above exemplifies the benefits of the present composition made from organic aggregates such as vegetables, fruits, natural minerals and natural fibers, among others, to provide protection with the fireproof, intumescent and water-repellent, passive technology and protection coating of the present invention, giving the opportunity to protect wooden poles, wooden houses, trees by protecting them from fires and/or wildfires that occur when dry grass burns and spreads into trees, ending up losing trees that are 10-<50 years old.

Cardboard plates are the test samples to be used to test the performance and efficacy of the composition to form a usually aqueous, fireproof, intumescent and water-repellent coating. Cardboard from an egg carton was used. They were trimmed to a measurement of 11.81 inches×11.81 inches (300 mm×300 mm) and 0.19 inches (5 mm) thick. The sample was prepared and coated with the fireproof, intumescent and water-repellent coating in two layers. A thin layer of the white fireproof, intumescent and water-repellent coating with a film thickness of 10 mils (0.25 mm) was applied by air spraying. For curing, 24 hours of drying at room temperature is required for each coat applied. Thus, for 20 mils (0.508 mm) 48 hours of drying were required, to achieve a setting and optimal homogeneous rigid hardening.

The equipment to perform the fire resistance tests was a pyrometer to measure elevated temperatures up to 2912° F. (1600° C.), two pairs of K-type thermocouples to measure temperatures up to 2372° F. (1300° C.), where 1 pair of thermocouples measured the coating-coated temperature on the front, while the other thermocouple measured the temperature on the back, which has no coating application. Temperature readings were taken at 10-minute intervals.

Once the test sample was cured, the cardboard plate was coated on one side with the fireproof, intumescent and water-repellent coating, with a thickness of 20 mils (0.508 mm).

The test sample was subjected to temperature increase by means of a butane gas torch that generated a direct-fire flame. The fire was concentrated at a fixed point and within 5 minutes there was a temperature of 770° F. (410° C.). Within 10 minutes it reached a temperature of 1427° F. (775° C.).

In the physical phenomenon of the carbonization process of the rigid thin layers applied to the fireproof, intumescent and water-repellent coating of this invention, when exposed to high temperatures in the first 10 minutes and during the resistance test, they did not allow flames or smoke to penetrate the cardboard (substrate) preventing heat transfer. Heat radiation was completely isolated by means of its 10 mils (0.25 mm) thick, sealing, multicellular carbonaceous layers, absorbing heat radiation, repelling it, withstanding heat radiation with temperatures from 1427 to 1862.6° F. (775 to 1017° C.) for 60 minutes of direct fire protection, while the second thin, rigid layer, 10 thousandths of an inch thick (0.254 mm) supported the thermal insulation, tightness, stability and resistance of the cardboard board (substrate), protecting it to prevent flames from reaching the substrate. Surprisingly, the flames did not penetrate the uncoated backside, as there was no mark of heat transfer. It was possible to put the palm of our hand even with the direct flame of the torch at a distance of only 0.21 inches (5.5 mm), without perception that the heat radiation penetrated through the cardboard plate coated with the composition to form a fireproof, intumescent, water-repellent, usually aqueous coating of the invention. This assured that the heat radiation did not pass. The cardboard sample withstood the test with a temperature of 1688° F. (920° C.), while the back side had a temperature of 77° F. (25° C.) taken with the thermocouple.

The temperature measurement in the example above is as shown in the table below.

| | Temperature | Temperature |
|---|---|---|
| Time [min] | [° F.] Hot Face | [° F.] Cold Face |
| 0 | 73 (23° C.) | 73 (23° C.) |
| 5 | 770 (410° C.) | 75 (24° C.) |
| 10 | 1427 (775° C.) | 77 (25° C.) |
| 20 | 1688 (920° C.) | 77 (25° C.) |
| 30 | 1863 (1017° C.) | 81 (27° C.) |
| 40 | 1679 (915° C.) | 79 (26° C.) |
| 50 | 1585 (863° C.) | 77 (25° C.) |
| 60 | 1373 (745° C.) | 77 (25° C.) |
| 70 | 1796 (980° C.) | 84 (29° C.) |
| 80 | 140 (60° C.) | 79 (26° C.) |

This test showed that the first rigid thin layer protects the substrate and provided thermal insulation, stability, watertightness and resistance to the cardboard board without generating fume.

On the back of the cardboard there was no transfer of heat radiation and at the temperature measured with the thermocouple there was a temperature variation of 42.8° F. (6° C.) over the course of 1 hour.

The composition to form a usually aqueous fireproof, intumescent, water-repellent coating of the present invention of passive, fire-preventive technology, is particularly suitable in its properties and technology which are intumescent, protect materials that do not burn but lose their original properties of rigidity and stability when subjected to high temperatures and/or fire directly, such as concrete and steel. It is manufactured and developed for the protection of steel load-bearing metal structures in the construction of buildings or houses and is applied in structures such as: pillars, columns, type “I” and “H” beams, steel slab floors and mezzanines, load-bearing walls, ceilings, partitions, concrete walls and walls, etc., guaranteeing the stability of buildings and limiting the development of fire to prevent its collapse. The fireproof, intumescent, and water-repellent passive fire protection coating composition of the present invention can be applied to any substrate without the need to apply a primer or base coat bonded to the substrate. In particular, in buildings constructed with steel structures where conventional paints do not easily adhere to such steel structures.

Another property of the composition of the coating is that it is fireproof, protecting flammable materials such as wood, drywall, recycled PET panels, fiberglass, cardboard, polystyrene foam, among others, protecting them from high temperatures against fire, in determined times of 30 to 240 minutes, by means of its thin, rigid, sealant layers of application of fireproof, intumescent and water-repellent coating, preventing the spread of flames to other adjacent areas. The most important thing is that the start of the fire is contained in the place started and mitigated there without spreading to other areas, encapsulating the fire. When applied to walls and ceilings, it also delays, mitigates and minimizes the effects of a fire, providing time for evacuation with the primary objective of safeguarding the life of living beings in general.

The fireproof, intumescent and water-repellent passive preventive technology coating composition of the present invention, can be applied by means of brush, roller or spray and is applied in mixed buildings such as: hotels, hospitals, schools, shopping malls, cinemas, theaters, auditoriums, parking lots, restaurants, kindergartens, laboratories, prisons, dens, canteens, factories, warehouses, industrial warehouses, museums, galleries, churches, markets, supply centers, bus stations, government buildings, wooden houses, condominiums, automobiles, wooden poles, wind turbines, airplanes, hangars, rockets, spaceships, satellites, railroads, racing and racing cars, batteries, ships, airports, refineries, chemical plants, gas plants, offshore platforms, petrochemical plants, trees (forest fires), etc.

The fireproof, intumescent and water-repellent coating of this invention also protects buildings that provide mixed services, places where we live, study, work or play that must be safe in the event of a fire. Its uses and applications also include sectors such as: automotive, pharmaceutical, hospitality, space, manufacturing, electrical, textile, food, petrochemical, aeronautical, gasoline and gas, mining, commerce, transport, construction, fishing, industrial, education, culture and others.

The present invention can also be presented as a paste-type fireproof mortar with a rough appearance that protects and maintains the stability of buildings in the event of a fire. It withstands temperatures from 1292 to 2012° F. (700° C. to 1100° C.) for each thin, rigid, applied layer with a thickness of 0.2527 mils (0.25 mm), for required times of 3 to 4 hours and with a single thickness of 0.7581 mils (0.02 mm) dry thickness. Its installation is very clean and simple by means of a brush, roller or electric airless equipment, providing maximum adhesion, providing aesthetics and finish to steel metal structures, walls, retarding, mitigating and minimizing the effects of flames.

Unlike cement-based, gypsum-based, vermiculite-based, mineral wool-based cementitious fireproof mortars, they are applied by means of pneumatic spraying machines. Cement spraying, depending on the project or structure, requires thicknesses of 0.39 to 1.96 inches (10 to 50 mm) according to the required protection in determined times of 30 to 240 minutes, adding weight to the structures, with presentation in bags of 22.05 to 55.12 lb (10 to 25 kg) that are diluted in water.

In another embodiment, this invention is presented in powder, without modifying its fireproof and water-repellent composition, being now not passive protection but active protection against fires, now facing a fire that has already started. The spray drying process is known to be a refined method, for drying solid substances from aqueous or organic solutions, suspensions and emulsions, to produce dry, consistent, functional powders, precisely defined, with uniform density and robust agglomerates, which are easily dissolved again in water.

The spray drying processes are as follows:

Concentration: to reduce the amount of liquid to be evaporated.

Atomization: to drive a dry product that has the desired characteristic.

Air contact with droplets: The atomized liquid comes into contact with hot air in the drying chamber, resulting in evaporation of the water. The way in which the dew comes into contact with the blown air influences the behavior of the droplets in the drying phase and directly affects the properties of the dry product.

Drip drying: Evaporation of moisture in 2 stages. The water that evaporates from the surface is replaced by more water molecules of the volume.

It begins when there is no longer enough moisture to maintain the saturated condition on the surface of the droplet.

It causes a dry layer to form on the surfaces, the evaporation rate decreases, and the layer thickens.

### Separation:

Primary. Heavy particles simply fall to the bottom of the drying chamber, a small fraction if the fine particles remain entrained in the air.

Secondary separation cyclone separator and electrostatic precipitator, final separation filter bags or wet purifying used to purify and cool the air.

The powder, which can be obtained according to the above, provides an active protection extinguishing powder that is a solid substance in a powdery state, used for fire extinguishing, called dry powder, multipurpose powder, with its composition based on organic aggregates, minerals and natural physical elements, which provide fire suppression properties that are extinguished by cooling the fuel. The molecules of the extinguishing agent absorb energy that is transformed into an increase in their temperature when the state of vaporization changes, and in the breaking of the chemical bonds between their atoms.

According to the present invention, an embodiment thereof can be supplied as an extinguishing powder for the extinction of forest fires, for aerial spraying launched from airplanes and helicopters, being a solid substance active against fires in a powdery state, its configuration is based on organic aggregates obtained from vegetables, fruits, minerals and natural fibers.

According to the present invention, another embodiment of the invention can be supplied as an extinguishing powder in form of spheres, which is portable, lightweight, non-toxic, contains no heavy chemicals and is halogen-free. It is a solid substance active against fires in a powdery state, which is supplied in 2.2 lb (1.0 Kg) spheres that help fight any type of fire, extinguishing it instantly within a radius of 32.29 square foot (3 square meters). In this case, there are 2 types of use, the first is automatic in the presence of a type A, B, C fire, the sphere is activated automatically and will spread at 360° degrees in that diameter of 32.29 square foot (3 square meters). The second use is manual, which in the event of a fire throws the sphere and will go out instantly.

According to the present invention, another embodiment thereof can be supplied as a fire extinguishing powder for charging fire extinguishers, being a solid substance active against fires in a powdery state. Fire extinguishers are steel containers, pressurized with inert gas of 217.56 to 246.56 psi (15 to 17 bar) Fire extinguishing powder consists of saline compounds, organic aggregates, minerals, and natural fibers. The composition of these aggregates creates a barrier that prevents the entry of oxygen, the universal extinguishing powder acts as a catalyst inhibiting the combustion reaction, and the extinguishing of the fire by suppression effect.

According to the present invention, another embodiment thereof can be supplied as a universal extinguishing powder, which is a dry powder that is used to extinguish fires class A “combustible solids”, class B “combustible liquids and gases”, class C “energized electrical equipment”, being found in different presentations of 2.2, 4.41, 9.92, 11.02, 13.22, 19.84, 26.45 lb (1, 2, 4.5, 5, 6, 9, 12 kg) and others.

According to the present invention, another embodiment thereof can be supplied as an aerosol. In the fireproof and water-repellent composition of the present invention, aerosol propellant is added. An LPG gas is used to propel the substances contained in aerosols, it is fast drying, has a yield of 10.76 to 16.14 ft2 (1 to 1.5 m²) per can, is kept at high pressure inside the canister, in a partially liquid state. The propellant is mixed with the liquid to be vaporized.

The goal of the embodiment is to spray the steam and not the liquid, so the valve is designed to capture the steam from the top of the can, when the can is shaken, twisted or flipped, the valve is squeezed and it will expel the pulverized liquid.

According to the present invention, another embodiment thereof can be supplied as a fireproof and water-repellent composition of the present invention in the form of a silicone in a gun canister. This requires additional organic and inorganic aggregates, which can be one or a mixture of more than one aggregate. Among them is the primary product for its configuration, which is silica (silicon dioxide), as well as polymers that have in common a chain in which silicon (Si) and oxygen (O) atoms alternate and are strongly linked by covalent bonds, each silicon atom being linked to two organic radicals.

Silicone is an odorless and colorless polymer composed mainly of silicon that is used to glue or seal materials and whose main virtue is that it maintains a certain elasticity once applied.

The transformation to elastic solids is achieved through the elastic polymer polymerization process. It is a thermoplastic adhesive for bonding surfaces such as wood, glass, cardboard, fine metals, porcelain, fiberglass, porcelain, or plastics, when consolidated in a cylindrical container.

According to the present invention, another embodiment thereof can be supplied as a gypsum board which is a lightweight material essentially of gypsum, reinforced with resistant fibers, covered on both sides with recycled paper for core protection. It is used on interior and exterior walls, in construction projects, remodeling, partition walls, to protect walls and ceilings of construction sites. They are manufactured in a variety of standard lengths and thicknesses for use in construction, fire bounding, wildland fire containment booms, etc.

According to the present invention, another embodiment thereof can be supplied as a cement panel which is a panel with a lightened cement core between two layers of fiberglass mesh, resistant to impacts, which is used for the creation of exterior walls, facades, dividing fences, fire boundary, etc. Wildfire containment booms, which are manufactured in a variety of standard lengths and thicknesses.

According to the present invention, another embodiment thereof can be supplied as a metal panel with insulating core and exterior or interior steel cladding of composite systems for walls or roofs, facades, dividing fences, fire boundaries, forest fire containment barriers, which are designed in a variety of thicknesses and profiles, and standard lengths for construction use.

According to the present invention, another embodiment thereof can be supplied as panels insulated by high levels of thermal insulation that are manufactured with glass fiber coatings, wood, cardboard, polystyrene foam. They are lightweight panels used in construction projects for interior and exterior walls, partition walls, facades, dividing bars, fire boundaries, forest fire containment barriers; they are designed in a variety of standard lengths and thicknesses for use in construction.

All of the above fire containment walls are coated with the fireproof, intumescent and water-repellent coating of the present invention and feature passive fire prevention technology. The coating is applied by means of application or air spraying, in different film thicknesses depending on the construction project according to the type of panel and its coating.

The thin, rigid layers of coating provide excellent thermal resistance and protection that create a thermal insulating barrier against the ignition source and initiation of combustion, providing robust protection when exposed to high temperatures and extreme turbulent forces in any fire generated by either cellulosic fire 1000° F. (538° C.) or hydrocarbon-type fire 2100° F. (1149° C.).

Each thin rigid layer of coating applied to the panels features a natural glassy finish that does not crack, not peel off, not disintegrate due to its high adhesion properties to the substrate of each fire containment panel, protecting it against exposure in the spread of fires. These barrier panels prevent the spread of fires.

Each thin rigid layer applied of coating on the containment panels, protects them from moisture, acts as an integral waterproofing clogging pores, obstructing the entire capillary microscopic network preventing the filtration of water and moisture. It protects from wear and environmental degradation due to extreme weather changes such as sun, UV rays, wind, dust, rain, humidity, low temperatures of 86° F. (30° C.) as in snow, preventing crystallization.

The present invention is a very special solution for wooden houses that have disadvantages that make them vulnerable to internal or external fires such as grassland burning or forest fires; When a wildfire spreads, there will be losses of several homes and even entire inhabited regions.

In the face of forest fires that shrink forests, the death of trees due to fire is one of the most destructive forces on earth, which can undoubtedly be mitigated and contained by means of boundary panels using the present invention. Containment panels with the composition of the present invention may well be a solution to avoid forest losses of up to 6 million hectares per year. This option can be a solution to restore the safeguarding of forests in fire-adapted ecosystems and the prevention of catastrophic events that alter soils, wildlife, and water quality.

The containment panels in conjunction with the composition of the present invention form fire containment barriers, which manage to contain and mitigate the fire for determined times from 60 to 240 minutes, depending on their lengths and thicknesses of each rigid thin layer applied of the invention, to limit and limit the vertical spread of fires, protecting real estate (buildings), forests, wooden houses, etc., with the main objective being to safeguard human and wildlife life.

The examples and embodiments of the invention detailed above are for illustrative purposes only and do not limit in any way the scope of the present invention.

1. A fire protection passive intumescent and water-repellent fireproof coating composition comprising:
(a) a dehydrating agent, (b) a binding agent, (c) a source of organic acid, (d) a source of organic carbon, (e) organic polymers, (f) a fireproof agent, (g) thermosetting elastomers, (h) an organic adherent agent, (i) a resin agent, and (j) a fiber agent,
wherein the composition is applied in the form of at least a first layer that, when in contact with heat radiation by combustion, does not form a thick carbonaceous layer that is detached and does not generate fume.

2. The fire protection passive intumescent and water-repellent fireproof coating composition according to claim 1, wherein when the binding agent decomposes between 392 and 752° F. (200 and 400° C.) by increasing temperature provides a source of acids, the dehydration reaction of which with the active aggregates of the binding agent acidifies and produces gases that form a gas source.

3. The fire protection passive intumescent and water-repellent fireproof coating composition according to claim 1, wherein the dehydrating agent extracts water from the binding agent and the organic carbon source forming a film of glass and microscopic quartz flakes.

4. The fire protection passive intumescent and water-repellent fireproof coating composition according to claim 1, wherein when the binding agent binds together it acidifies itself to generate silicic acid and the organic acid source is added to achieve a pH of 6.63.

5. The fire protection passive intumescent and water-repellent fireproof coating composition according to claim 1, wherein thermosetting elastomers limit the degradation of organic agents to decrease heat radiation, preventing the fireproof coating from becoming numb, as well as eliminating the emission of fumes.

6. The fire protection passive intumescent and water-repellent fireproof coating composition according to claim 1, wherein the organic carbon source decomposes at a temperature of about 392° F. producing a thermal process involving melting and decomposition when the binding agent acidifies with increasing temperature there is a reversal reaction of the organic carbon source to its melting point transforming into a thin layer with a carbonaceous structure.

7. The fire protection passive intumescent and water-repellent fireproof coating composition according to claim 1, wherein the organic polymers are transformed into a rigid, thin layer of carbonaceous structure and thermal insulation, wherein the gas source absorbs heat energy during the process of expansion and thermal boiling, forming bubbles that are released and burst on the surface, isolating the thermal conductivity of the [1] carbonaceous thin layer before stiffening.

8. The fire protection passive intumescent and water-repellent fireproof coating composition according to claim 1, wherein the fireproof agent inhibits combustion by affecting radicalary reactions, absorbs heat radiation forming barriers to the passage of oxygen interrupting the combustion cycle, reducing radiant energy levels from 2192 to 77° F. (1200 to 25° C.) in seconds, eliminating the progression of fumes and preventing the spread of fire, generating a layer of thermal insulation to combustion.

9. The fire protection passive intumescent and water-repellent fireproof coating composition according to claim 1, wherein thermosetting elastomers do not melt when they reach a temperature of 1256° F. maintaining the structure of the multicellular carbonaceous thin layer in a solid, difficult to remove state, preventing the binding agent, the organic carbon source, the fireproof agent, the organic adhering agent, and the fiber agent to be fused in the combustion zone in the intumescence process without degrading, wherein the fireproof agent mitigates the combustion cycle.

10. The fire protection passive intumescent and water-repellent fireproof coating composition according to claim 1, wherein the organic adherent agent when dehydrated by the dehydrating agent forms a viscous plant substance acting as an organic additive adherent providing a natural glassy finish.

11. The fire protection passive intumescent and water-repellent fireproof coating composition according to claim 10, wherein the organic adherent agent forms an adherent protective layer that reacts against the ignition source, whereby when two thin layers of coating are applied, the protective layer adheres between the multicellular carbonaceous layer and the inner rigid thin layer of support, providing thermal protection, high adhesion properties that withstand extreme turbulent forces in a hydrocarbon fire.

12. The fire protection passive intumescent and water-repellent fireproof coating composition according to claim 1, wherein the matrix of the crystallization resin agent composition, which is composed of a mixture with calcium silicate, by reacting with a chemical base of amino alcohols and organic minerals are dispersed together with the binding agent containing quartz minerals, wherein the silicate becomes progressively more viscous, and wherein the removal of water absorbed by the dehydrating agent converts the silicate into a glassy film of quartz on the outside of each rigid thin layer of fireproof coating.

13. The fire protection passive intumescent and water-repellent fireproof coating composition according to claim 12, wherein additionally the dehydration and crystallization of the silicate is generated, converting it into microscopic quartz flakes, wherein together, the water-repellent agents are mixed with bituminous emulsions, waxes, fatty acids and butylestereates, that allow lubrication, causing them to slide through the internal capillary system of the fireproof coating, that inside the substances are activated and form invasive non-soluble quartz crystals, which obstruct the entire capillary microscopic network, in any crack up of up to 0.0016 inches (0.04 millimeters) of thickness, preventing the filtration of water and moisture, completely drying the fireproof coating.

14. The fire protection passive intumescent and water-repellent fireproof coating composition according to claim 1, wherein the fiber agent is selected from inorganic fibers that provide more resistance to wear and environmental degradation with extreme weather changes, such as rain, sun, wind, UV rays, dust, moisture, water vapor, snow and prevents crystallization, which protects the natural glassy finish of each rigid thin layer applied, eliminating the possibility of instability in the face of high temperatures and fire containment.

15. The fire protection passive intumescent and water-repellent fireproof coating composition according to claim 14, wherein polymeric synthetic inorganic fibers reduce shrinkage cracks, prevent micro-cracks, anti-filtration of liquids, prevent fractures in tensile, bending, shear stress, torsional stress states, provide maximum adhesion to aggregates and resistance to impacts that are dispersed over a multi-directional network to reinforce each applied rigid thin layer of the intumescent and water-repellent fireproof coating.

16. The fire protection passive intumescent and water-repellent fireproof coating composition according to claim 1, wherein the amount of the dehydrating agent is representative between 8-19% by weight based on the total weight of the composition.

17. The fire protection passive intumescent and water-repellent fireproof coating composition according to claim 1, wherein the amount of binding agent is representative between 46%-61% by weight based on the total weight of the composition.

18. The fire protection passive intumescent and water-repellent fireproof coating composition according to claim 1, wherein the amount of the organic acid source is representative of 0.4 to 2.9% based on the total weight of the composition of the fireproof coating.

19. The fire protection passive intumescent and water-repellent fireproof coating composition according to claim 1, wherein the amount of organic carbon source is representative of 0.2-2.58% based on the total weight of the composition of the fireproof coating.

20. The fire protection passive intumescent and water-repellent fireproof coating composition according to claim 1, wherein the amount of organic polymers is representative between 0.2-2.9% based on the total weight of the composition.

21.-56. (canceled)

57. The fire protection passive intumescent and water-repellent fireproof coating composition according to claim 1, wherein the amount of the fireproof agent is representative between 1%-4.7% based on the total weight of the composition.

58. The fire protection passive intumescent and water-repellent fireproof coating composition according to claim 1, wherein the amount of thermosetting elastomers is representative between 22-37% by weight, based on the total weight of the composition.

59. The fire protection passive intumescent and water-repellent fireproof coating composition according to claim 1, wherein the amount of an organic adherent agent is representative between 0.1-3.6% by weight based on the total weight of the composition.

60. The fire protection passive intumescent and water-repellent fireproof coating composition according to claim 1, wherein the amount of a resin agent is representative between 0.2-3.7% by weight based on the total weight of the composition.

61. The fire protection passive intumescent and water-repellent fireproof coating composition according to claim 1, wherein the amount of fiber agent is representatively between 0.2-4.1% by weight based on the total weight of the composition.

62. The fire protection passive intumescent and water-repellent fireproof coating composition according to claim 1, wherein the dehydrating agent is selected from a group of naturally occurring, fibrous metamorphic minerals composed of double-chain silicates, iron, aluminum, sodium, and magnesium complexes.

63. The fire protection passive intumescent and water-repellent fireproof coating composition according to claim 62, wherein the dehydrating agent is sodium silicate fibers.

64. The fire protection passive intumescent and water-repellent fireproof coating composition according to claim 1, wherein the binding agent is selected from the group comprising the family of ortho-silicates, meta-silicates and pyrosilicates or any ester containing a chemical group.

65. The fire protection passive intumescent and water-repellent fireproof coating composition according to claim 64, wherein the binding agent is liquid or powdered sodium silicate.

66. The fire protection passive intumescent and water-repellent fireproof coating composition according to claim 4, wherein the source of organic acid is citric acid.

67. The fire protection passive intumescent and water-repellent fireproof coating composition according to claim 19, wherein the organic carbon source comprises carbohydrates.

68. The fire protection passive intumescent and water-repellent fireproof coating composition according to claim 20, wherein the organic polymers comprise organic polysaccharide polymers, wherein the organic polymers contribute to the transformation of the thin layer of carbonaceous structure and at the end of the boiling process, in its stiffness.

69. The fire protection passive intumescent and water-repellent fireproof coating composition according to claim 1, wherein the source of organic carbon is sucrose.

70. The fire protection passive intumescent and water-repellent fireproof coating composition according to claim 1, wherein the fireproof agent is preferably perlite.

71. The fire protection passive intumescent and water-repellent fireproof coating composition according to claim 1, wherein the organic adherent agent is mucilage of Opuntia ficus.

72. The fire protection passive intumescent and water-repellent fireproof coating composition according to claim 1, wherein the fiber agent is polypropylene.

73. An intumescent and water-repellent fireproof coating passive system comprising the composition of claim 1, which is applied in place of cementitious mortar, wherein the composition is presented as a paste-type fireproof mortar with a rough appearance that protects and maintains the stability of buildings in the event of a fire, wherein installation of the composition is by means of brush, roller or electric airless equipment, providing maximum adhesion, providing aesthetics and finish to steel metal structures, walls, retarding, mitigating and minimizing the effects of flames.

74. An intumescent and water-repellent fireproof coating passive system comprising the composition of claim 1, which may be supplied as a fire containment panel selected from the group consisting of gypsum panel, cement panel, metal panels and panels made of glass fiber coatings, wood, cardboard, and polystyrene foam.

75. A fire protection active fireproof and water-repellent composition comprising:
(a) a dehydrating agent, (b) a binding agent, (c) a source of organic acid, (d) a source of organic carbon, (e) organic polymers, (f) a fireproof agent, (g) thermosetting elastomers, (h) an organic adherent agent, (i) a resin agent, and (j) a fiber agent, wherein the composition is in the form of a powder, aerosol or a silicone.

76. The fire protection active fireproof and water-repellent composition of claim 75, wherein the amount of the dehydrating agent is representative between 8-19% by weight based on the total weight of said composition.

77. The fire protection active fireproof and water-repellent composition of claim 75, wherein the amount of binding agent is representative between 46%-61% by weight based on the total weight of said composition.

78. The fire protection active fireproof and water-repellent composition of claim 75, wherein the amount of the organic acid source is representative of 0.4 to 2.9% based on the total weight of said composition.

79. The fire protection active fireproof and water-repellent composition of claim 75, wherein the amount of organic carbon source is representative of 0.2-2.58% based on the total weight of such composition.

80. The fire protection active fireproof and water-repellent composition of claim 75, wherein the amount of organic polymers is representative between 0.2-2.9% based on the total weight of such composition.

81. The fire protection active fireproof and water-repellent composition of claim 75, wherein the amount of the fireproof agent is representative between 1%-4.7% based on the total weight of said composition.

82. The fire protection active fireproof and water-repellent composition of claim 75, wherein the amount of thermosetting elastomers is representative between 22-37% by weight, based on the total weight of said composition.

83. The fire protection active fireproof and water-repellent composition of claim 75, wherein the amount of an organic adherent agent is representative between 0.1-3.6% by weight based on the total weight of said composition.

84. The fire protection active fireproof and water-repellent composition of claim 75, wherein the amount of a resin agent is representative between 0.2-3.7% by weight based on the total weight of such composition.

85. The fire protection active fireproof and water-repellent composition of claim 75, wherein the amount of fiber agent is representatively between 0.2-4.1% by weight based on the total weight of such composition.

86. The fire protection active fireproof and water-repellent composition of claim 75, wherein said dust may be present in fire extinguishers, in portable spheres and in containers suitable for extinguishing forest fires by aerial spraying.

87. A fire protection active fireproof and water-repellent system comprising the fireproof and water-repellent composition in liquid form of claim 75, which may be supplied as an aerosol, wherein an aerosol propellant and an LPG gas are added to propel the substances contained in such aerosols, wherein the propellant is mixed with the liquid to be vaporized.

88. A fire protection active fireproof and water-repellent system comprising the fireproof and water-repellent composition in liquid form of claim 75, in the form of silicone in gun canister.

89. The fire protection passive intumescent and water-repellent fireproof coating composition according to claim 1, wherein said first applied rigid thin layer of coating is 0.2524 mils (0.006411 mm) of thickness withstanding 1652 to 2192° F. (900 to 1200° C.) temperature, at specified times of 60 minutes for each rigid and thin layer, to protect the substrate, thereby ensuring the stability of steel or other building materials and at least a second rigid thin layer applied of said coating, exposed to fire that does not allow heat transfer, keeping it below its critical yield temperature of less than 932° F. (500° C.), even at high temperatures of the nature of 2012° F. (1100° C.).

90. The fire protection passive intumescent and water-repellent fireproof coating composition according to claim 89, wherein application between one layer and another does not require the use of any element such as a support mesh applied between each layer for both cellulosic fires and hydrocarbon fires.

91. The fire protection passive intumescent and water-repellent fireproof coating composition according to claim 1, wherein said composition provides a fireproof coating wherein the rigid thin layers thereof have a mineral quartz glassy finish that withstands on the outside, extreme weather changes such as sun, rain, wind, UV rays, dust, moisture, water vapor, snow, which does not crystallize, erode, peel off and do not disintegrate due to its high adhesion properties.

92. The fire protection passive intumescent and water-repellent fireproof coating composition according to claim 1, wherein said composition can be applied to any substrate without the need to apply a primer or base layer adhered to the substrate.
